(19) United States
(12) Patent Application Publication
(10) Pub. No.: US 2026/0230240 A1
(43) Pub. Date: Aug. 6, 2026

(54) METHOD AND DEVICE FOR PERFORMING LOW-LATENCY ULTRA-HIGH SPEED TRANSMISSION IN WIRELESS COMMUNICATION SYSTEM

(71) Applicant: LG Electronics Inc., Seoul (KR)

(72) Inventors: Jongku LEE, Seoul (KR); Kijun KIM, Seoul (KR); Dongsun LEE, Seoul (KR)

(21) Appl. No.: 19/159,169

(22) PCT Filed: Feb. 24, 2023
(86) PCT No.: PCT/KR2023/002688

§ 371 Date: Aug. 22, 2025

(51) Int. Cl. H04L 1/20; H04L 1/1812; H04W 72/232

(52) U.S. Cl. CPC H04L 1/203; H04L 1/1812; H04W 72/232

(57) ABSTRACT

According to various embodiments of the present disclosure, a method performed by a UE is provided. The method may include receiving a radio resource control (RRC) message including information for a target BLER of a transmission unit including multiple code blocks, first code block information, and first retransmission information, receiving DCI including second code block information and second retransmission information, acquiring information for a number of the multiple code blocks, receiving first code blocks which are a part of the multiple code blocks, acquiring a number of first code blocks in which a transmission error occurs among the first code blocks, acquiring an expected BLER of the transmission unit, generating a HARQ-ACK feedback, transmitting the HARQ-ACK feedback, and re-receiving code blocks related to the HARQ-ACK feedback.

### TECHNICAL FIELD

The present disclosure relates to a wireless communication system. More particularly, the present disclosure relates to a method and device for performing a low-latency and ultra-high-speed transmission in a wireless communication system.

### BACKGROUND ART

Wireless access systems are widely deployed to provide various types of communication services, such as voice and data. In general, the wireless access system is a multiple access system capable of supporting communication with multiple users by sharing available system resources (bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as many communication devices require large communication capacity, more enhanced mobile broadband (eMBB) communication technology than the existing radio access technology (RAT) is proposed. Not only massive machine type communications (mMTC) which provide various services anytime and anywhere by connecting a large number of devices and objects, but also a communication system considering service/user equipment (UE) sensitive to reliability and latency are proposed. Various technical configurations for this are proposed.

### DISCLOSURE

### Technical Solution

A method performed by a user equipment (UE) in a wireless communication system according to an embodiment of the present disclosure may comprise receiving one or more synchronization signals from a base station, receiving configuration information from the base station, receiving control information from the base station, receiving, from the base station, a radio resource control (RRC) message including information on a target block error rate (BLER) of a transmission unit including multiple code blocks, first code block information for the multiple code blocks, and first retransmission information for a hybrid automatic repeat request-acknowledgment (HARQ-ACK), receiving, from the base station, downlink control information (DCI) including second code block information for the multiple code blocks and second retransmission information for the HARQ-ACK, acquiring information on a number of the multiple code blocks based on the first code block information and the second code block information, receiving, from the base station, first code blocks which are a part of the multiple code blocks, acquiring a number of first code blocks in which a transmission error occurs among the first code blocks, acquiring an expected BLER of the transmission unit based on a number of the first code blocks, the number of the first code blocks in which the transmission error occurs, and an expected BLER of second code blocks which are a remaining part of the multiple code blocks, generating a HARQ-ACK feedback based on the target BLER of the transmission unit, the expected BLER of the transmission unit, and the first retransmission information, transmitting the HARQ-ACK feedback to the base station based on the second retransmission information, and re-receiving, from the base station, code blocks related to the HARQ-ACK feedback.

At least one of the first retransmission information or the second retransmission information may include transmission time information of a proactive HARQ-ACK.

Acquiring the information on the number of the multiple code blocks may comprise acquiring a number of bits based on the second code block information, performing a quantization on the number of bits based on the first code block information, and acquiring the information on the number of the multiple code blocks based on the number of bits on which the quantization is performed and a maximum size of the multiple code blocks.

Performing the quantization on the number of bits based on the first code block information may comprise generating at least one group based on the number of bits, and applying a different bias value to each of the at least one group.

Re-receiving, from the base station, the code blocks related to the HARQ-ACK feedback may comprise re-receiving the code blocks related to the HARQ-ACK feedback on a per CBG basis.

The method may further comprise acquiring information on a number of data code blocks (DCBs), information on a number of parity code blocks (PCBs), and information on a number of code block groups (CBGs) based on the first code block information, the second code block information, or the number of the multiple code blocks.

Acquiring the information on the number of the CBGs may comprise acquiring the information on the number of the CBGs based on information on a minimum number of code blocks per CBG and information on a maximum number of the CBGs.

A user equipment (UE) in a wireless communication system according to an embodiment of the present disclosure may comprise a transceiver, a memory including at least one instruction, and at least one processor performing the at least one instruction, wherein the at least one instruction may comprise receiving one or more synchronization signals from a base station, receiving configuration information from the base station, receiving control information from the base station, receiving, from the base station, a radio resource control (RRC) message including information on a target block error rate (BLER) of a transmission unit including multiple code blocks, first code block information for the multiple code blocks, and first retransmission information for a hybrid automatic repeat request-acknowledgment (HARQ-ACK), receiving, from the base station, downlink control information (DCI) including second code block information for the multiple code blocks and second retransmission information for the HARQ-ACK, acquiring information on a number of the multiple code blocks based on the first code block information and the second code block information, receiving, from the base station, first code blocks which are a part of the multiple code blocks, acquiring a number of first code blocks in which a transmission error occurs among the first code blocks, acquiring an expected BLER of the transmission unit based on a number of the first code blocks, the number of the first code blocks in which the transmission error occurs, and an expected BLER of second code blocks which are a remaining part of the multiple code blocks, generating a HARQ-ACK feedback based on the target BLER of the transmission unit, the expected BLER of the transmission unit, and the first retransmission information, transmitting the HARQ-ACK feedback to the base station based on the second retransmission information, and re-receiving, from the base station, code blocks related to the HARQ-ACK feedback.

At least one of the first retransmission information or the second retransmission information may include transmission time information of a proactive HARQ-ACK.

Acquiring the information on the number of the multiple code blocks may comprise acquiring a number of bits based on the second code block information, performing a quantization on the number of bits based on the first code block information, and acquiring the information on the number of the multiple code blocks based on the number of bits on which the quantization is performed and a maximum size of the multiple code blocks.

Performing the quantization on the number of bits based on the first code block information may comprise generating at least one group based on the number of bits, and applying a different bias value to each of the at least one group.

Re-receiving, from the base station, the code blocks related to the HARQ-ACK feedback may comprise re-receiving the code blocks related to the HARQ-ACK feedback on a per CBG basis.

The at least one instruction may further comprise acquiring information on a number of data code blocks (DCBs), information on a number of parity code blocks (PCBs), and information on a number of code block groups (CBGs) based on the first code block information, the second code block information, or the number of the multiple code blocks.

Acquiring the information on the number of the CBGs may comprise acquiring the information on the number of the CBGs based on information on a minimum number of code blocks per CBG and information on a maximum number of the CBGs.

A method performed by a base station in a wireless communication system according to an embodiment of the present disclosure may comprise transmitting one or more synchronization signals to a user equipment (UE), transmitting configuration information to the UE, transmitting control information to the UE, transmitting, to the UE, a radio resource control (RRC) message including information on a target block error rate (BLER) of a transmission unit including multiple code blocks, first code block information for the multiple code blocks, and first retransmission information for a hybrid automatic repeat request-acknowledgment (HARQ-ACK), transmitting, to the UE, downlink control information (DCI) including second code block information for the multiple code blocks and second retransmission information for the HARQ-ACK, transmitting, to the UE, first code blocks which are a part of the multiple code blocks included in the transmission unit, transmitting, to the UE, second code blocks which are a remaining part of the multiple code blocks, receiving, from the UE, a HARQ-ACK feedback generated based on a reception state of the first code blocks, and re-transmitting, to the UE, code blocks related to the HARQ-ACK feedback based on the HARQ-ACK feedback.

At least one of the first retransmission information or the second retransmission information may include transmission time information of a proactive HARQ-ACK.

Re-transmitting, to the UE, the code blocks related to the HARQ-ACK feedback based on the HARQ-ACK feedback may comprise re-transmitting, to the UE, the code blocks related to the HARQ-ACK feedback based on the HARQ-ACK feedback sequentially to the transmission of the second code blocks.

A base station in a wireless communication system according to an embodiment of the present disclosure may comprise a transceiver, a memory including at least one instruction, and at least one processor performing the at least one instruction, wherein the at least one instruction may comprise transmitting one or more synchronization signals to a user equipment (UE), transmitting configuration information to the UE, transmitting control information to the UE, transmitting, to the UE, a radio resource control (RRC) message including information on a target block error rate (BLER) of a transmission unit including multiple code blocks, first code block information for the multiple code blocks, and first retransmission information for a hybrid automatic repeat request-acknowledgment (HARQ-ACK), transmitting, to the UE, downlink control information (DCI) including second code block information for the multiple code blocks and second retransmission information for the HARQ-ACK, transmitting, to the UE, first code blocks which are a part of the multiple code blocks included in the transmission unit, transmitting, to the UE, second code blocks which are a remaining part of the multiple code blocks, receiving, from the UE, a HARQ-ACK feedback generated based on a reception state of the first code blocks, and re-transmitting, to the UE, code blocks related to the HARQ-ACK feedback based on the HARQ-ACK feedback.

Re-transmitting, to the UE, the code blocks related to the HARQ-ACK feedback based on the HARQ-ACK feedback may comprise re-transmitting, to the UE, the code blocks related to the HARQ-ACK feedback based on the HARQ-ACK feedback sequentially to the transmission of the second code blocks.

A device according to an embodiment of the present disclosure may comprise one or more memories and one or more processors operably connected to the one or more memories, wherein the one or more processors may operate the device to receive one or more synchronization signals from a base station, receive configuration information from the base station, receive control information from the base station, receive, from the base station, a radio resource control (RRC) message including information on a target block error rate (BLER) of a transmission unit including multiple code blocks, first code block information for the multiple code blocks, and first retransmission information for a hybrid automatic repeat request-acknowledgment (HARQ-ACK), receive, from the base station, downlink control information (DCI) including second code block information for the multiple code blocks and second retransmission information for the HARQ-ACK, acquire information on a number of the multiple code blocks based on the first code block information and the second code block information, receive, from the base station, first code blocks which are a part of the multiple code blocks, acquire a number of first code blocks in which a transmission error occurs among the first code blocks, acquire an expected BLER of the transmission unit based on a number of the first code blocks, the number of the first code blocks in which the transmission error occurs, and an expected BLER of second code blocks which are a remaining part of the multiple code blocks, generate a HARQ-ACK feedback based on the target BLER of the transmission unit, the expected BLER of the transmission unit, and the first retransmission information, transmit the HARQ-ACK feedback to the base station based on the second retransmission information, and re-receive, from the base station, code blocks related to the HARQ-ACK feedback.

One or more non-transitory computer readable mediums according to an embodiment of the present disclosure may store one or more instructions, wherein the one or more non-transitory computer readable mediums may operate to receive one or more synchronization signals from a base station, receive configuration information from the base station, receive control information from the base station, receive, from the base station, a radio resource control (RRC) message including information on a target block error rate (BLER) of a transmission unit including multiple code blocks, first code block information for the multiple code blocks, and first retransmission information for a hybrid automatic repeat request-acknowledgment (HARQ-ACK), receive, from the base station, downlink control information (DCI) including second code block information for the multiple code blocks and second retransmission information for the HARQ-ACK, acquire information on a number of the multiple code blocks based on the first code block information and the second code block information, receive, from the base station, first code blocks which are a part of the multiple code blocks, acquire a number of first code blocks in which a transmission error occurs among the first code blocks, acquire an expected BLER of the transmission unit based on a number of the first code blocks, the number of the first code blocks in which the transmission error occurs, and an expected BLER of second code blocks which are a remaining part of the multiple code blocks, generate a HARQ-ACK feedback based on the target BLER of the transmission unit, the expected BLER of the transmission unit, and the first retransmission information, transmit the HARQ-ACK feedback to the base station based on the second retransmission information, and re-receive, from the base station, code blocks related to the HARQ-ACK feedback.

### Advantageous Effects

The present disclosure can provide a method and device for performing a low-latency and ultra-high-speed transmission in a wireless communication system.

According to the present disclosure, when a large amount of data is transmitted through multiple shared channels scheduled via one DCI, transmission latency can be reduced by lowering the probability of retransmission using an erasure code,

According to the present disclosure, when retransmission is inevitably required, transmission latency can be reduced through proactive HARQ-ACK feedback.

According to the present disclosure, when retransmission is required compared to a multi-slot scheduling technology and a CBG-based retransmission technology of 5G NR, an amount of required radio resources can be reduced by retransmitting only some CBGs or transmitting a small number of additional PCBs instead of retransmitting all shared channels or all CBGs in which errors occur.

According to the present disclosure, a technology is provided that can recover code blocks in which errors occur using code blocks in which no error occurs, thereby obtaining diversity gain when signal quality between the code blocks is not constant.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates a method of processing a transmitted signal applicable to the present disclosure.

FIG. 4 illustrates another example of a wireless device applicable to the present disclosure.

FIG. 5 illustrates an example of a hand-held device applicable to the present disclosure.

FIG. 6 illustrates physical channels applicable to the present disclosure and a signal transmission method using the same.

FIG. 7 illustrates the structure of a radio frame applicable to the present disclosure.

FIG. 8 illustrates a slot structure applicable to the present disclosure.

FIG. 9 illustrates an example of a communication structure providable in a 6G system applicable to the present disclosure.

FIG. 10 illustrates an example of a structure of a perceptron.

FIG. 11 illustrates an example of a structure of a multilayer perceptron.

FIG. 12 illustrates an example of a deep neural network.

FIG. 13 illustrates an example of a convolutional neural network.

FIG. 14 illustrates an example of a filter operation in a convolutional neural network.

FIG. 15 illustrates an example of a neural network structure in which a circular loop exists.

FIG. 16 illustrates an example of an operation structure of a recurrent neural network.

FIG. 17 illustrates an electromagnetic spectrum applicable to the present disclosure.

FIG. 18 illustrates a THz communication method applicable to the present disclosure.

FIG. 19 illustrates a THz wireless communication transceiver applicable to the present disclosure.

FIG. 20 illustrates a THz signal generation method applicable to the present disclosure.

FIG. 21 illustrates a wireless communication transceiver applicable to the present disclosure.

FIG. 22 illustrates a transmitter structure applicable to the present disclosure.

FIG. 23 illustrates a modulator structure applicable to the present disclosure.

FIG. 24 is a conceptual diagram illustrating an embodiment of a procedure of transmitting by applying an internal channel code after applying an erasure code to multiple code blocks in a system applicable to the present disclosure.

FIG. 25 is a conceptual diagram illustrating a method of transmitting and receiving data in a system applicable to the present disclosure.

FIG. 26 is a conceptual diagram illustrating the minimum number of PCBs required to achieve a target BLER of a transmission unit according to an embodiment of the present disclosure.

FIG. 27 is a conceptual diagram illustrating a redundancy ratio according to an embodiment of the present disclosure.

FIG. 28 is a flowchart illustrating a method of obtaining the number of DCBs and the number of PCBs according to an embodiment of the present disclosure.

FIG. 29 is a conceptual diagram illustrating HARQ-ACK feedback and retransmission according to an embodiment of the present disclosure.

FIG. 30 is a flowchart illustrating a method for a receiving end to determine a retransmission method according to an embodiment of the present disclosure.

FIG. 31 is a flowchart illustrating a method of determining a retransmission method according to an embodiment of the present disclosure.

FIG. 32 is a conceptual diagram illustrating a transmission latency reduction method according to an embodiment of the present disclosure.

FIG. 33 is a conceptual diagram illustrating a transmission latency reduction method according to another embodiment of the present disclosure.

FIG. 34 is a flowchart illustrating an operation procedure of a UE according to an embodiment of the present disclosure.

FIG. 35 is a flowchart illustrating an operation procedure of a base station according to an embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an UpLink (UL). Likewise, the mobile station may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

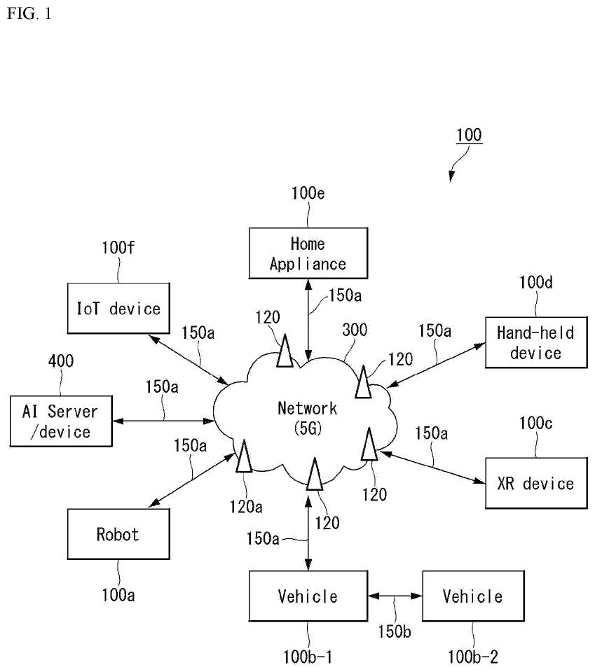

FIG. 1 illustrates an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

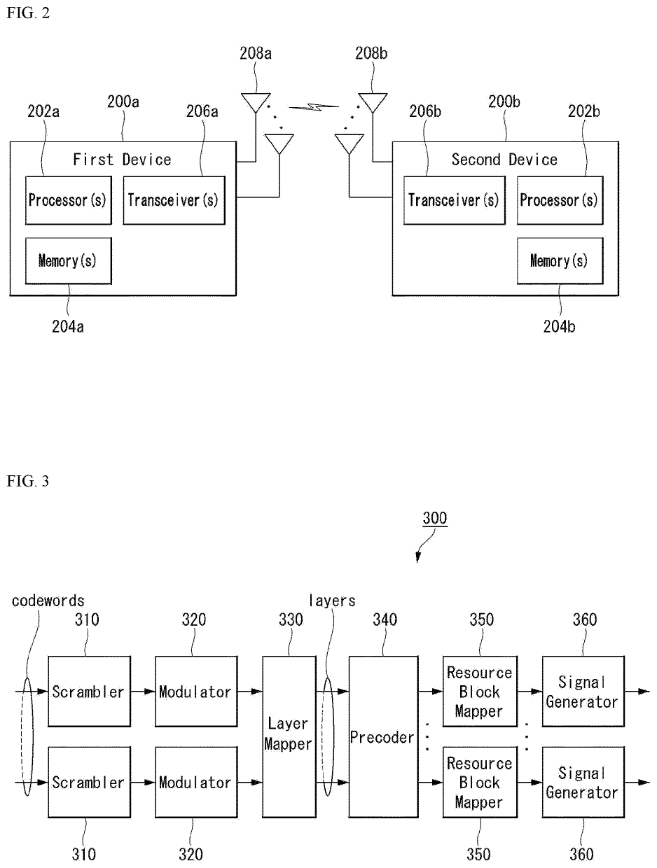

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be connected with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be connected with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be connected with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be connected with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be connected with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be connected with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

FIG. 3 illustrates a method of processing a transmitted signal applicable to the present disclosure. For example, the transmitted signal may be processed by a signal processing circuit. At this time, a signal processing circuit 300 may include a scrambler 310, a modulator 320, a layer mapper 330, a precoder 340, a resource mapper 350, and a signal generator 360. At this time, for example, the operation/function of FIG. 3 may be performed by the processors 202a and 202b and/or the transceiver 206a and 206b of FIG. 2. In addition, for example, the hardware element of FIG. 3 may be implemented in the processors 202a and 202b of FIG. 2 and/or the transceivers 206a and 206b of FIG. 2. For example, blocks 1010 to 1060 may be implemented in the processors 202a and 202b of FIG. 2. In addition, blocks 310 to 350 may be implemented in the processors 202a and 202b of FIG. 2 and a block 360 may be implemented in the transceivers 206a and 206b of FIG. 2, without being limited to the above-described embodiments. A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 6. Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### Structure of Wireless Device Applicable to the Present Disclosure

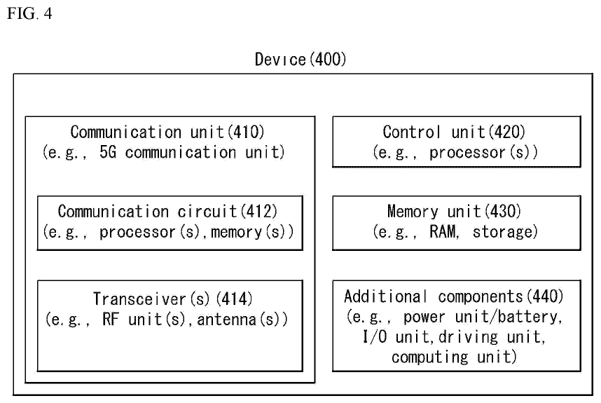

FIG. 4 illustrates another example of a wireless device applicable to the present disclosure.

Referring to FIG. 4, a wireless device 400 may correspond to the wireless devices 200a and 200b of FIG. 2 and include various elements, components, units/portions and/or modules. For example, the wireless device 300 may include a communication unit 410, a control unit (controller) 420, a memory unit (memory) 430 and additional components 440. The communication unit may include a communication circuit 412 and a transceiver(s) 414. For example, the communication circuit 412 may include one or more processors 202a and 202b and/or one or more memories 204a and 204b of FIG. 2. For example, the transceiver(s) 414 may include one or more transceivers 206a and 206b and/or one or more antennas 208a and 208b of FIG. 2. The control unit 420 may be electrically connected with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The additional components 440 may be variously configured according to the types of the wireless devices. For example, the additional components 440 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 4, various elements, components, units/portions and/or modules in the wireless device 400 may be connected with each other through wired interfaces or at least some thereof may be wirelessly connected through the communication unit 410. For example, in the wireless device 400, the control unit 420 and the communication unit 410 may be connected by wire, and the control unit 420 and the first unit (e.g., 130 or 140) may be wirelessly connected through the communication unit 410. In addition, each element, component, unit/portion and/or module of the wireless device 400 may further include one or more elements. For example, the control unit 420 may be composed of a set of one or more processors. For example, the control unit 420 may be composed of a set of a communication control processor, an application processor, an electronic control unit (ECU), a graphic processing processor, a memory control processor, etc. In another example, the memory unit 430 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

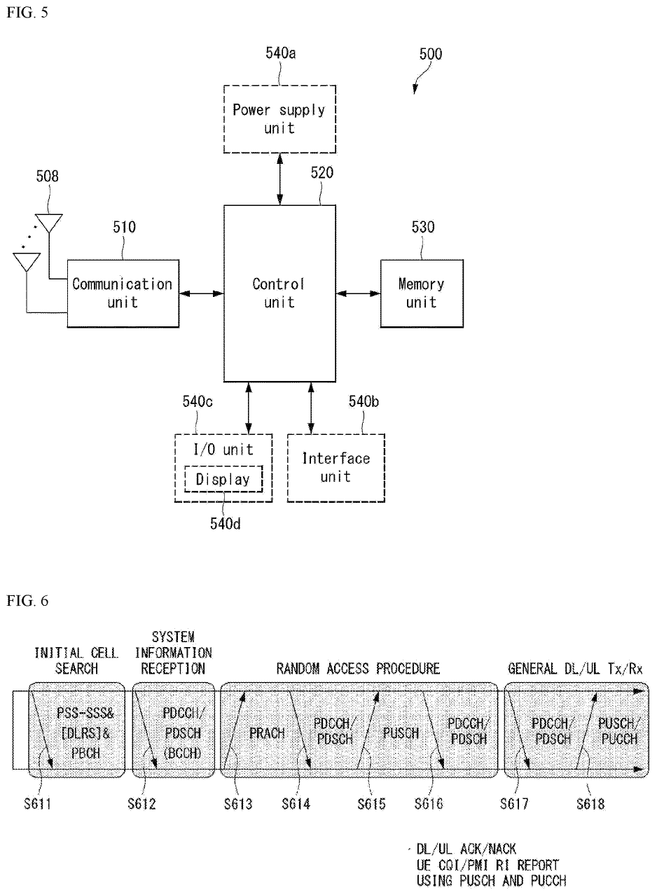

FIG. 5 illustrates an example of a hand-held device applicable to the present disclosure.

FIG. 5 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 5, the hand-held device 400 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/540a to 540c may correspond to the blocks 410 to 430/440 of FIG. 4, respectively.

The communication unit 510 may transmit and receive signals (e.g., data, control signals, etc.) to and from other wireless devices or base stations. The control unit 520 may control the components of the hand-held device 500 to perform various operations. The control unit 520 may include an application processor (AP). The memory unit 530 may store data/parameters/program/code/instructions necessary to drive the hand-held device 400. In addition, the memory unit 530 may store input/output data/information, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

### Physical Channels and General Signal Transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

FIG. 6 illustrates physical channels applicable to the present disclosure and a signal transmission method using the same.

The UE which is turned on again in a state of being turned off or has newly entered a cell performs initial cell search operation in step S611 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. The UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S612, thereby acquiring more detailed system information.

Thereafter, the UE may perform a random access procedure such as steps S613 to S616 in order to complete access to the base station. To this end, the UE may transmit a preamble through a physical random access channel (PRACH) (S613) and receive a random access response (RAR) to the preamble through a physical downlink control channel and a physical downlink shared channel corresponding thereto (S614). The UE may transmit a physical uplink shared channel (PUSCH) using scheduling information in the RAR (S615) and perform a contention resolution procedure such as reception of a physical downlink control channel signal and a physical downlink shared channel signal corresponding thereto (S616).

The UE, which has performed the above-described procedures, may perform reception of a physical downlink control channel signal and/or a physical downlink shared channel signal (S617) and transmission of a physical uplink shared channel (PUSCH) signal and/or a physical uplink control channel (PUCCH) signal (S618) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

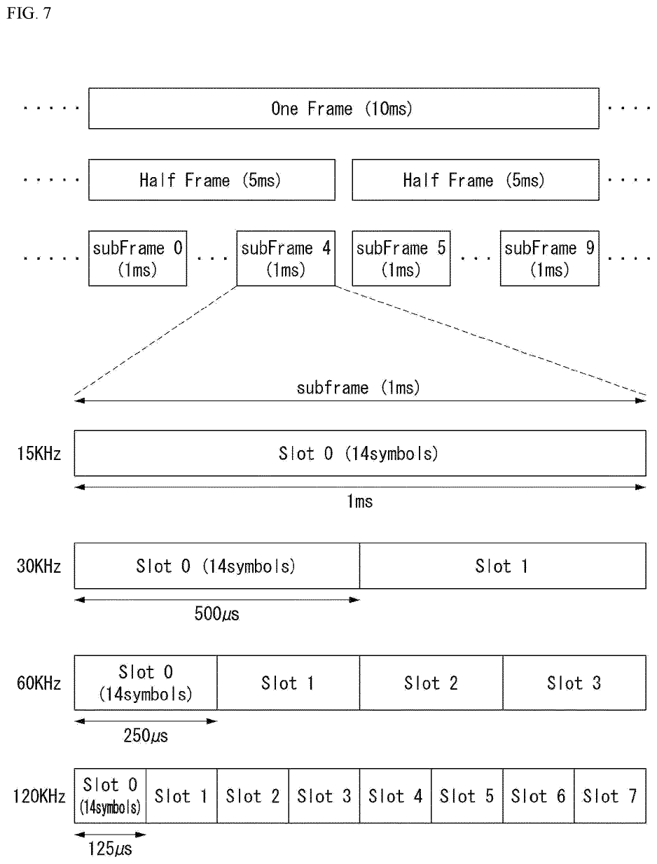

FIG. 7 illustrates the structure of a radio frame applicable to the present disclosure.

UL and DL transmission based on an NR system may be based on the frame shown in FIG. 7. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM (A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

Table 1 shows the number of symbols per slot according to SCS, the number of slots per frame and the number of slots per subframe when normal CP is used, and Table 2 shows the number of symbols per slot according to SCS, the number of slots per frame and the number of slots per subframe when extended CP is used.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

TABLE 2

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

In Tables 1 and 2 above,

$${N}_{symb}^{slot}$$

may indicate the number of symbols in a slot,

$${N}_{slot}^{frame , μ}$$

may indicate the number of slots in a frame, and

$${N}_{slot}^{subframe , μ}$$

may indicate the number of slots in a subframe.

In addition, in a system, to which the present disclosure is applicable, OFDM (A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support a plurality of numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise when the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

TABLE 3

| Frequency Range | Corresponding | Subcarrier | |
|---|---|---|---|
| designation | frequency range | Spacing | |
| FR1 | 410 MHz-7125 MHz | 15, 30, 60 | kHz |
| FR2 | 24250 MHz-52600 MHz | 60, 120, 240 | kHz |

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments. The THz band will be described below.

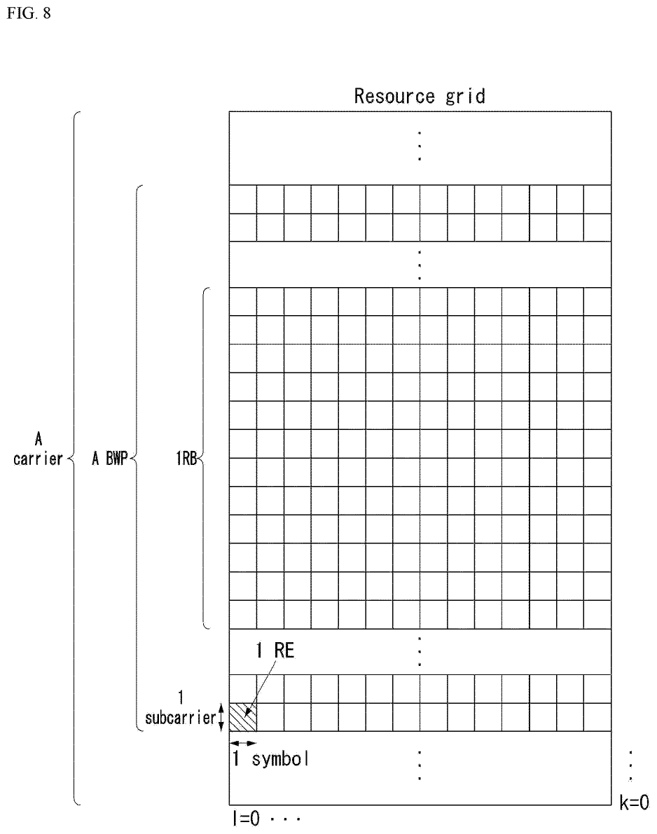

FIG. 8 illustrates a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P) RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 4

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

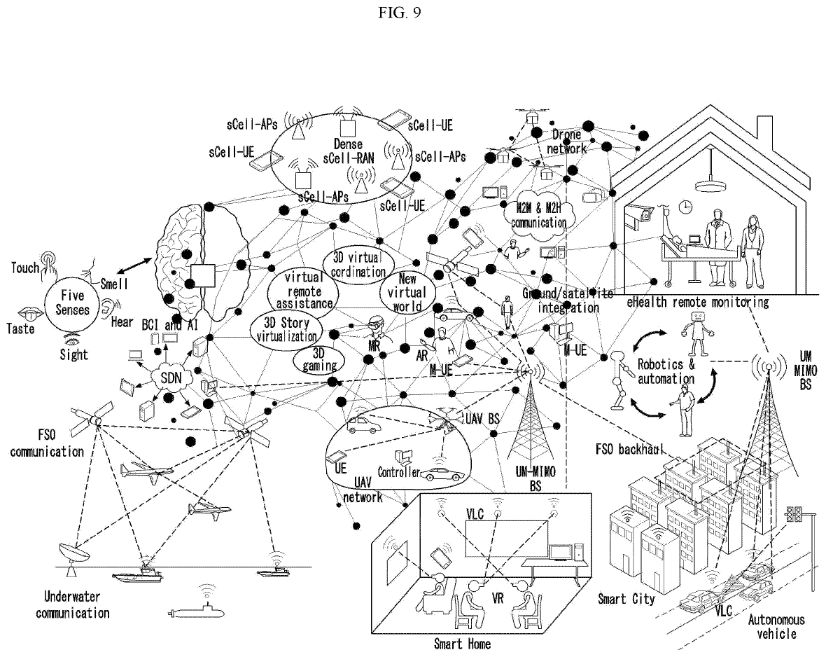

FIG. 9 illustrates an example of a communication structure providable in a 6G system applicable to the present disclosure.

Referring to FIG. 9, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### Core Implementation Technology of 6G System

### —Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to create a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

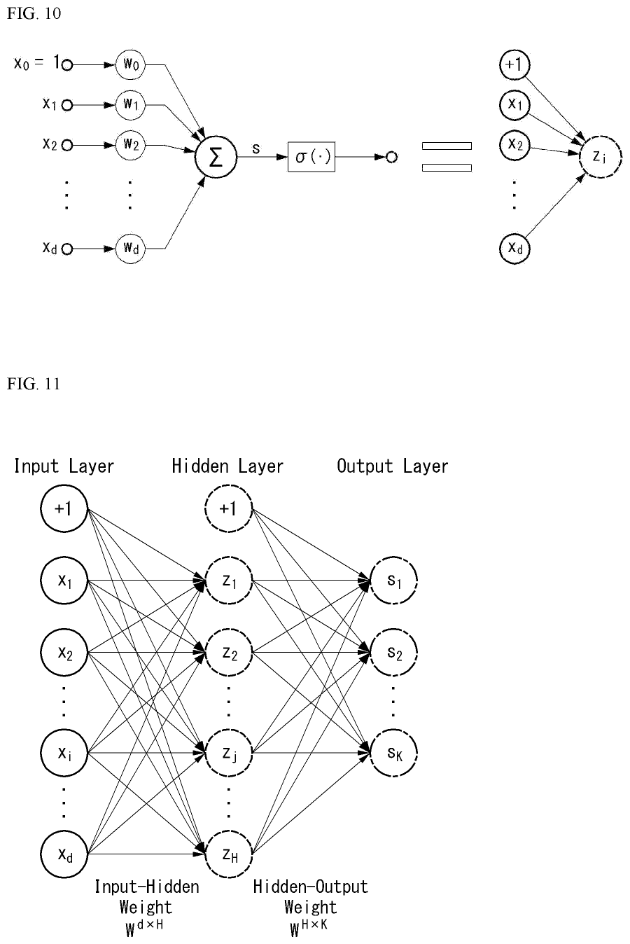

An artificial neural network is an example in which multiple perceptrons are connected. FIG. 10 illustrates an example of a structure of a perceptron.

Referring to FIG. 10, when an input vector x=(x1, x2, . . . , xd) is input, each component is multiplied by a weight (W1, W2, . . . , Wd), and all the results are summed. After that, the entire process of applying an activation function σ(⋅) is called a perceptron. The huge artificial neural network structure may extend the simplified perceptron structure illustrated in FIG. 10 to apply the input vector to different multidimensional perceptrons. For convenience of explanation, an input value or an output value is referred to as a node.

The perceptron structure illustrated in FIG. 10 may be described as consisting of a total of three layers based on the input value and the output value. FIG. 11 illustrates an artificial neural network in which the number of (d+1) dimensional perceptrons between a first layer and a second layer is H, and the number of (H+1) dimensional perceptrons between the second layer and a third layer is K, by way of example. FIG. 11 illustrates an example of a structure of a multilayer perceptron.

A layer where the input vector is located is called an input layer, a layer where a final output value is located is called an output layer, and all layers located between the input layer and the output layer are called a hidden layer. FIG. 11 illustrates three layers, by way of example. However, since the number of layers of the artificial neural network is counted excluding the input layer, it can be seen as a total of two layers. The artificial neural network is constructed by connecting the perceptrons of a basic block in two dimensions.

The above-described input layer, hidden layer, and output layer can be jointly applied in various artificial neural network structures, such as CNN and RNN to be described later, as well as the multilayer perceptron. The greater the number of hidden layers, the deeper the artificial neural network is, and a machine learning paradigm that uses the sufficiently deep artificial neural network as a learning model is called deep learning. In addition, the artificial neural network used for deep learning is called a deep neural network (DNN).

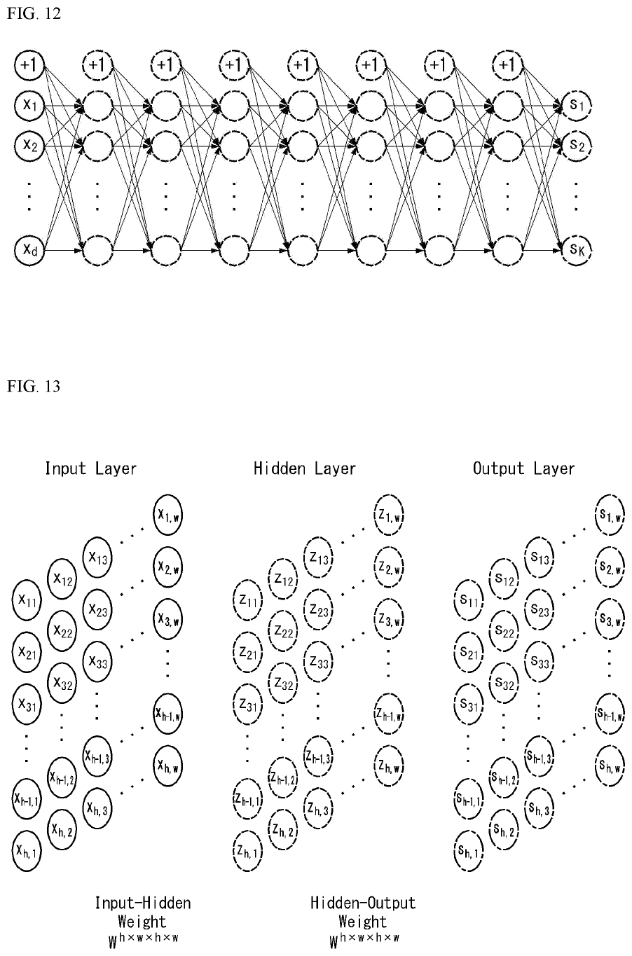

The deep neural network illustrated in FIG. 12 is a multilayer perceptron consisting of eight hidden layers+eight output layers. The multilayer perceptron structure is expressed as a fully connected neural network. In the fully connected neural network, a connection relationship does not exist between nodes located at the same layer, and a connection relationship exists only between nodes located at adjacent layers. The DNN has a fully connected neural network structure and is composed of a combination of multiple hidden layers and activation functions, so it can be usefully applied to understand correlation characteristics between input and output. The correlation characteristic may mean a joint probability of input and output.

Based on how the plurality of perceptrons are connected to each other, various artificial neural network structures different from the above-described DNN can be formed.

In the DNN, nodes located inside one layer are arranged in a one-dimensional longitudinal direction. However, in FIG. 13, it may be assumed that w nodes horizontally and h nodes vertically are arranged in two dimensions (convolutional neural network structure of FIG. 13). In this case, since in a connection process leading from one input node to the hidden layer, a weight is given for each connection, a total of h×w weights needs to be considered. Since there are h×w nodes in the input layer, a total of h2w2 weights are required between two adjacent layers.

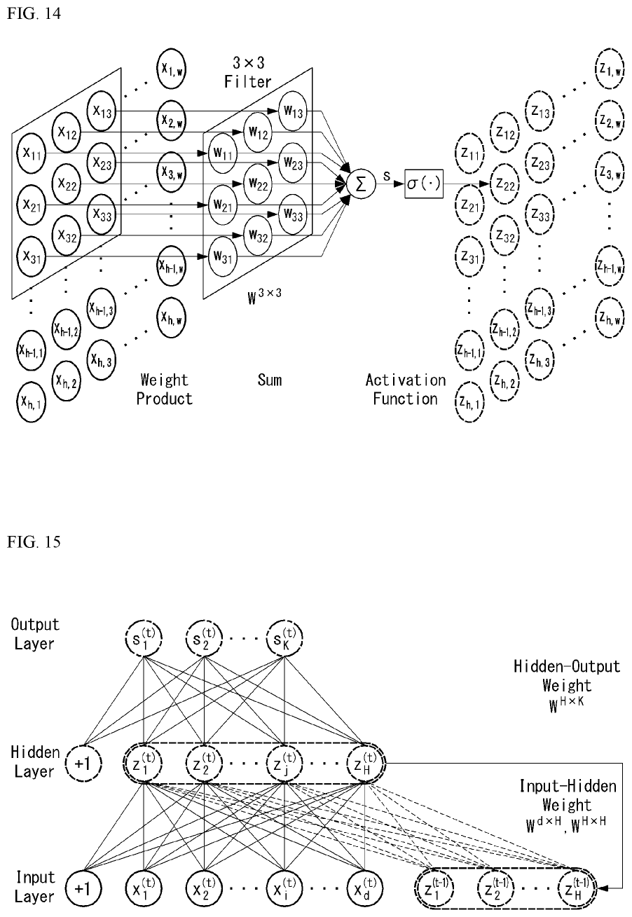

The convolutional neural network of FIG. 13 has a problem in that the number of weights increases exponentially depending on the number of connections. Therefore, instead of considering the connections of all the nodes between adjacent layers, it is assumed that a small-sized filter exists, and a weighted sum and an activation function calculation are performed on an overlap portion of the filters as illustrated in FIG. 14.

One filter has a weight corresponding to the number as much as its size, and learning of the weight may be performed so that a certain feature on an image can be extracted and output as a factor. In FIG. 14, a filter having a size of 3×3 is applied to the upper leftmost 3×3 area of the input layer, and an output value obtained by performing a weighted sum and an activation function calculation for a corresponding node is stored in z22.

The filter performs the weighted sum and the activation function calculation while moving horizontally and vertically by a predetermined interval when scanning the input layer, and places the output value at a location of a current filter. This calculation method is similar to the convolution operation on images in the field of computer vision. Thus, a deep neural network with this structure is referred to as a convolutional neural network (CNN), and a hidden layer generated as a result of the convolution operation is referred to as a convolutional layer. In addition, a neural network in which a plurality of convolutional layers exists is referred to as a deep convolutional neural network (DCNN).

At the node where a current filter is located at the convolutional layer, the number of weights may be reduced by calculating a weighted sum including only nodes located in an area covered by the filter. Hence, one filter can be used to focus on features for a local area. Accordingly, the CNN can be effectively applied to image data processing in which a physical distance on the 2D area is an important criterion. In the CNN, a plurality of filters may be applied immediately before the convolution layer, and a plurality of output results may be generated through a convolution operation of each filter.

There may be data whose sequence characteristics are important depending on data attributes. A structure, in which a method of inputting one element on the data sequence at each time step considering a length variability and a relationship of the sequence data and inputting an output vector (hidden vector) of a hidden layer output at a specific time step together with a next element on the data sequence is applied to the artificial neural network, is referred to as a recurrent neural network structure.

FIG. 15 illustrates an example of a neural network structure in which a circular loop exists.

Referring to FIG. 15, a recurrent neural network (RNN) is a structure in which in a process of inputting elements (x1(t), x2(t), . . . , xd(t)) of any line of sight ‘t’ on a data sequence to a fully connected neural network, hidden vectors (z1(t−1), z2(t−1), . . . , zH(t−1)) are input together at an immediately previous time step (t−1) to apply a weighted sum and an activation function. A reason for transferring the hidden vectors at a next time step is that information within the input vector in previous time steps is considered to be accumulated on the hidden vectors of a current time step.

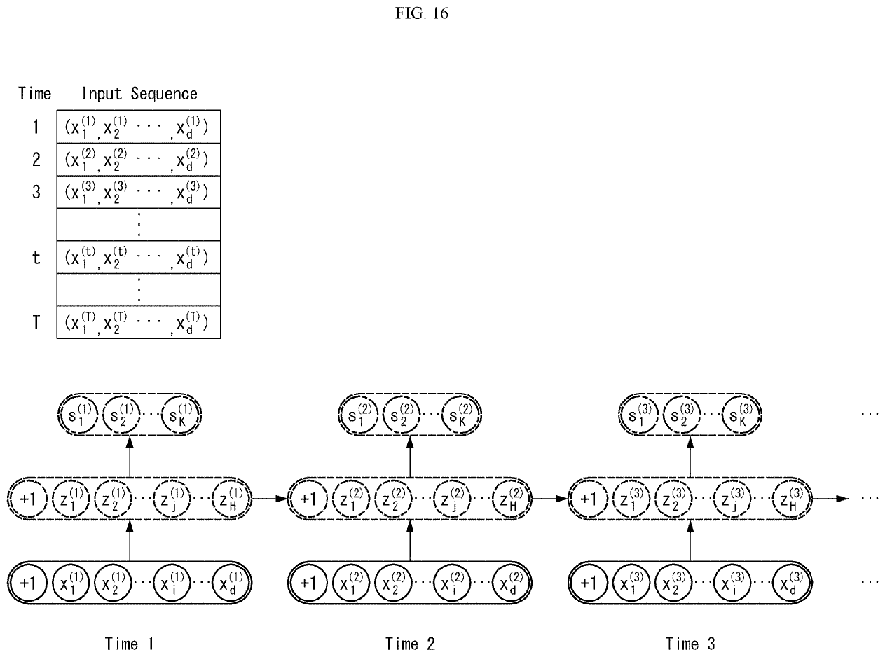

FIG. 16 illustrates an example of an operation structure of a recurrent neural network.

Referring to FIG. 16, the recurrent neural network operates in a predetermined order of time with respect to an input data sequence.

Hidden vectors (z1(1), z2(1), . . . , zH(1)) when input vectors (x1(t), x2(t), . . . , xd(t)) at a time step 1 are input to the recurrent neural network, are input together with input vectors (x1(2), x2(2), . . . , xd(2)) at a time step 2 to determine vectors (z1(2), z2(2), . . . , zH(2)) of a hidden layer through a weighted sum and an activation function. This process is repeatedly performed at time steps 2, 3, . . . , T.

When a plurality of hidden layers are disposed in the recurrent neural network, this is referred to as a deep recurrent neural network (DRNN). The recurrent neural network is designed to be usefully applied to sequence data (e.g., natural language processing).

A neural network core used as a learning method includes various deep learning methods such as a restricted Boltzmann machine (RBM), a deep belief network (DBN), and a deep Q-network, in addition to the DNN, the CNN, and the RNN, and may be applied to fields such as computer vision, speech recognition, natural language processing, and voice/signal processing.

Recently, attempts to integrate AI with a wireless communication system have appeared, but this has been concentrated in the field of wireless resource management and allocation in the application layer, network layer, in particular, deep learning. However, such research is gradually developing into the MAC layer and the physical layer, and in particular, attempts to combine deep learning with wireless transmission in the physical layer have appeared. The AI-based physical layer transmission refers to applying a signal processing and communication mechanism based on an AI driver, rather than a traditional communication framework in the fundamental signal processing and communication mechanism. For example, deep learning-based channel coding and decoding, deep learning-based signal estimation and detection, deep learning-based MIMO mechanism, AI-based resource scheduling and allocation, and the like, nay be included.

### Terahertz (THz) Communication

THz communication is applicable to the 6G system. For example, a data rate may increase by increasing bandwidth. This may be performed by using sub-TH communication with wide bandwidth and applying advanced massive MIMO technology.

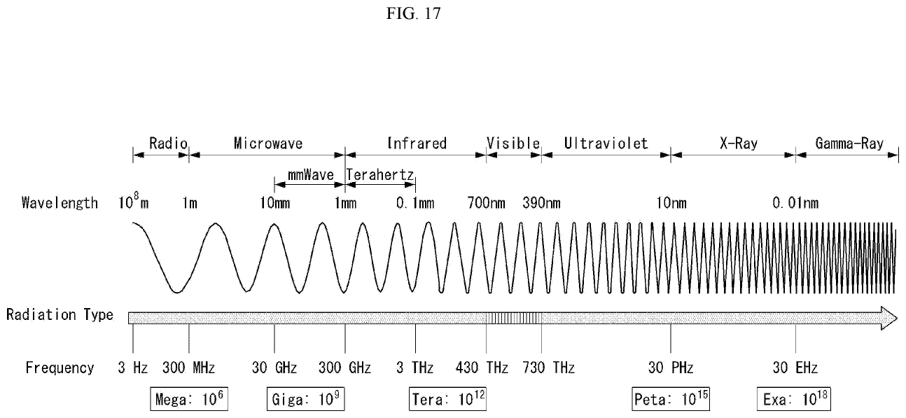

FIG. 17 illustrates an electromagnetic spectrum applicable to the present disclosure. For example, referring to FIG. 17, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mm Wave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### Optical Wireless Technology

Optical wireless communication (OWC) technology is planned for 6G communication in addition to RF based communication for all possible device-to-access networks. This network is connected to a network-to-backhaul/fronthaul network connection. OWC technology has already been used since 4G communication systems but will be more widely used to satisfy the requirements of the 6G communication system. OWC technologies such as light fidelity/visible light communication, optical camera communication and free space optical (FSO) communication based on wide band are well-known technologies. Communication based on optical wireless technology may provide a very high data rate, low latency and safe communication. Light detection and ranging (LiDAR) may also be used for ultra high resolution 3D mapping in 6G communication based on wide band.

### FSO Backhaul Network

The characteristics of the transmitter and receiver of the FSO system are similar to those of an optical fiber network. Accordingly, data transmission of the FSO system similar to that of the optical fiber system. Accordingly, FSO may be a good technology for providing backhaul connection in the 6G system along with the optical fiber network. When FSO is used, very long-distance communication is possible even at a distance of 10,000 km or more. FSO supports mass backhaul connections for remote and non-remote areas such as sea, space, underwater and isolated islands. FSO also supports cellular base station connections.

### Massive MIMO Technology

One of core technologies for improving spectrum efficiency is MIMO technology. When MIMO technology is improved, spectrum efficiency is also improved. Accordingly, massive MIMO technology will be important in the 6G system. Since MIMO technology uses multiple paths, multiplexing technology and beam generation and management technology suitable for the THz band should be significantly considered such that data signals are transmitted through one or more paths.

### Blockchain

A blockchain will be important technology for managing large amounts of data in future communication systems. The blockchain is a form of distributed ledger technology, and distributed ledger is a database distributed across numerous nodes or computing devices. Each node duplicates and stores the same copy of the ledger. The blockchain is managed through a peer-to-peer (P2P) network. This may exist without being managed by a centralized institution or server. Blockchain data is collected together and organized into blocks. The blocks are connected to each other and protected using encryption. The blockchain completely complements large-scale IoT through improved interoperability, security, privacy, stability and scalability. Accordingly, the blockchain technology provides several functions such as interoperability between devices, high-capacity data traceability, autonomous interaction of different IoT systems, and large-scale connection stability of 6G communication systems.

### 3D Networking

The 6G system integrates terrestrial and public networks to support vertical expansion of user communication. A 3D BS will be provided through low-orbit satellites and UAVs. Adding new dimensions in terms of altitude and related degrees of freedom makes 3D connections significantly different from existing 2D networks.

### Quantum Communication

In the context of the 6G network, unsupervised reinforcement learning of the network is promising. The supervised learning method cannot label the vast amount of data generated in 6G. Labeling is not required for unsupervised learning. Thus, this technique can be used to autonomously build a representation of a complex network. Combining reinforcement learning with unsupervised learning may enable the network to operate in a truly autonomous way.

### Unmanned Aerial Vehicle

An unmanned aerial vehicle (UAV) or drone will be an important factor in 6G wireless communication. In most cases, a high-speed data wireless connection is provided using UAV technology. A base station entity is installed in the UAV to provide cellular connectivity. UAVs have certain features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC and mMTC. The UAV can also serve a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

### Cell-Free Communication

The tight integration of multiple frequencies and heterogeneous communication technologies is very important in the 6G system. As a result, a user can seamlessly move from network to network without having to make any manual configuration in the device. The best network is automatically selected from the available communication technologies. This will break the limitations of the cell concept in wireless communication. Currently, user movement from one cell to another cell causes too many handovers in a high-density network, and causes handover failure, handover delay, data loss and ping-pong effects. 6G cell-free communication will overcome all of them and provide better QoS. Cell-free communication will be achieved through multi-connectivity and multi-tier hybrid technologies and different heterogeneous radios in the device.

### Wireless Information and Energy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without batteries will be supported in 6G communication.

### Integration of Sensing and Communication

An autonomous wireless network is a function for continuously detecting a dynamically changing environment state and exchanging information between different nodes. In 6G, sensing will be tightly integrated with communication to support autonomous systems.

### Integration of Access Backhaul Network

In 6G, the density of access networks will be enormous. Each access network is connected by optical fiber and backhaul connection such as FSO network. To cope with a very large number of access networks, there will be a tight integration between the access and backhaul networks.

### Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram beamforming (HBF) is a new beamforming method that differs significantly from MIMO systems because this uses a software-defined antenna. HBF will be a very effective approach for efficient and flexible transmission and reception of signals in multi-antenna communication devices in 6G.

### Big Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

### Large Intelligent Surface (LIS)

In the case of the THz band signal, since the straightness is strong, there may be many shaded areas due to obstacles. By installing the LIS near these shaded areas, LIS technology that expands a communication area, enhances communication stability, and enables additional optional services becomes important. The LIS is an artificial surface made of electromagnetic materials, and can change propagation of incoming and outgoing radio waves. The LIS can be viewed as an extension of massive MIMO, but differs from the massive MIMO in array structures and operating mechanisms. In addition, the LIS has an advantage such as low power consumption, because this operates as a reconfigurable reflector with passive elements, that is, signals are only passively reflected without using active RF chains. In addition, since each of the passive reflectors of the LIS must independently adjust the phase shift of an incident signal, this may be advantageous for wireless communication channels. By properly adjusting the phase shift through an LIS controller, the reflected signal can be collected at a target receiver to boost the received signal power.

### THz Wireless Communication

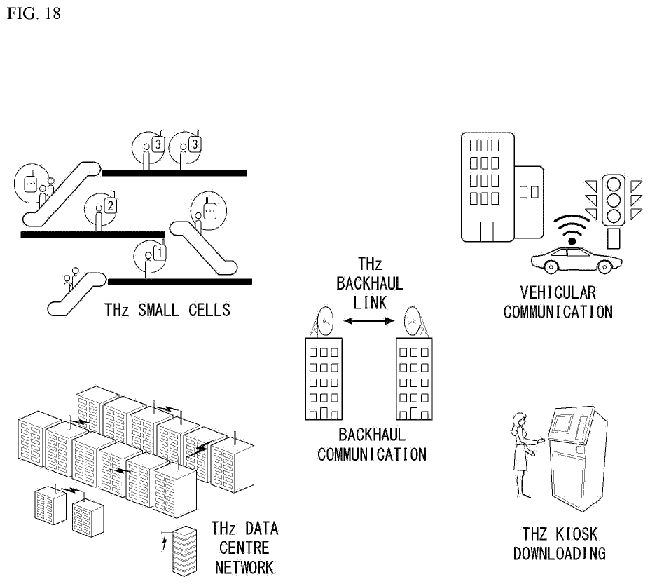

FIG. 18 illustrates a THz communication method applicable to the present disclosure.

Referring to FIG. 18, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

In addition, the photon energy of the THz wave is only a few meV and thus is harmless to the human body. A frequency band which will be used for THz wireless communication may be a D-band (110 GHz to 170 GHz) or a H-band (220 GHz to 325 GHz) band with low propagation loss due to molecular absorption in air. Standardization discussion on THz wireless communication is being discussed mainly in IEEE 802.15 THz working group (WG), in addition to 3GPP, and standard documents issued by a task group (TG) of IEEE 802.15 (e.g., TG3d, TG3e) specify and supplement the description of this disclosure. The THz wireless communication may be applied to wireless cognition, sensing, imaging, wireless communication, and THz navigation.

Specifically, referring to FIG. 18, a THz wireless communication scenario may be classified into a macro network, a micro network, and a nanoscale network. In the macro network, THz wireless communication may be applied to vehicle-to-vehicle (V2V) connection and backhaul/fronthaul connection. In the micro network, THz wireless communication may be applied to near-field communication such as indoor small cells, fixed point-to-point or multi-point connection such as wireless connection in a data center or kiosk downloading. Table 5 below shows an example of technology which may be used in the THz wave.

TABLE 5

| | |
|---|---|
| Transceivers Device | Available immature: UTC-PD, RTD and SBD |
| Modulation and | Low order modulation techniques (OOK, QPSK), |
| coding | LDPC, Reed Soloman, Hamming, Polar, Turbo |
| Antenna | Omni and Directional, phased array with low |
| | number of antenna elements |
| Bandwidth | 69 GHz (or 23 GHz) at 300 GHz |
| Channel models | Partially |
| Data rate | 100 Gbps |
| Outdoor deployment | No |
| Free space loss | High |
| Coverage | Low |
| Radio | 300 GHz indoor |
| Measurements | |
| Device size | Few micrometers |

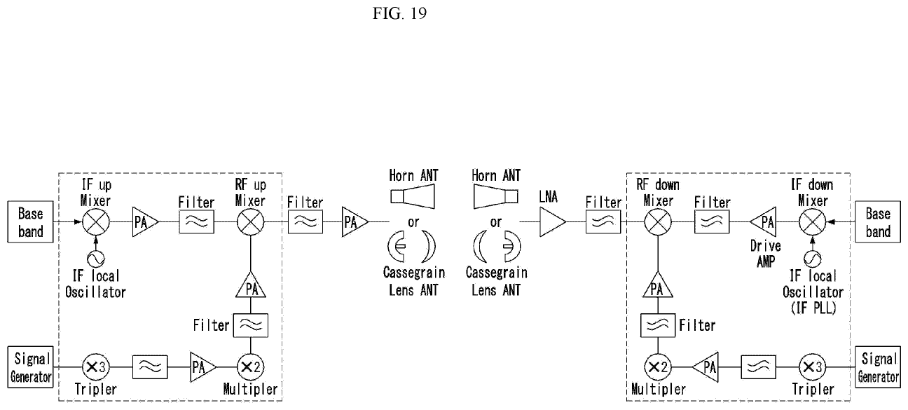

FIG. 19 illustrates a THz wireless communication transceiver applicable to the present disclosure.

Referring to FIG. 19, THz wireless communication may be classified based on the method of generating and receiving THz. The THz generation method may be classified as an optical device or electronic device based technology.

At this time, the method of generating THz using an electronic device includes a method using a semiconductor device such as a resonance tunneling diode (RTD), a method using a local oscillator and a multiplier, a monolithic microwave integrated circuit (MMIC) method using a compound semiconductor high electron mobility transistor (HEMT) based integrated circuit, and a method using a Si-CMOS-based integrated circuit. In the case of FIG. 19, a multiplier (doubler, tripler, multiplier) is applied to increase the frequency, and radiation is performed by an antenna through a subharmonic mixer. Since the THz band forms a high frequency, a multiplier is essential. Here, the multiplier is a circuit having an output frequency which is N times an input frequency, and matches a desired harmonic frequency, and filters out all other frequencies. In addition, beamforming may be implemented by applying an array antenna or the like to the antenna of FIG. 19. In FIG. 19, IF represents an intermediate frequency, a tripler and a multiplier represents a multiplier, PA represents a power amplifier, and LNA represents a low noise amplifier, and PLL represents a phase-locked loop.

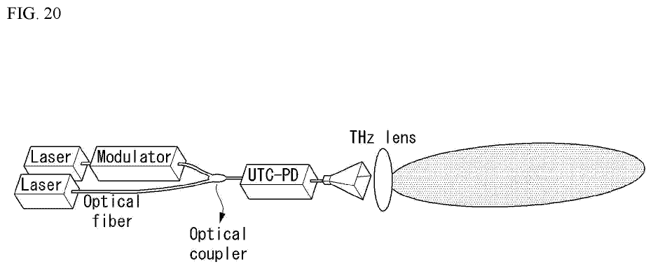

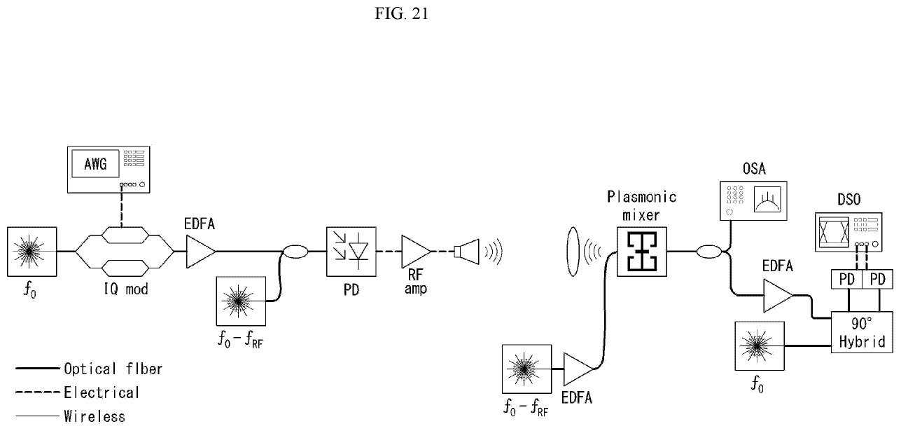

FIG. 20 illustrates a THz signal generation method applicable to the present disclosure. FIG. 21 illustrates a wireless communication transceiver applicable to the present disclosure.

Referring to FIGS. 20 and 21, the optical device-based THz wireless communication technology means a method of generating and modulating a THz signal using an optical device. The optical device-based THz signal generation technology refers to a technology that generates an ultrahigh-speed optical signal using a laser and an optical modulator, and converts it into a THz signal using an ultrahigh-speed photodetector. This technology is easy to increase the frequency compared to the technology using only the electronic device, can generate a high-power signal, and can obtain a flat response characteristic in a wide frequency band. In order to generate the THz signal based on the optical device, as shown in FIG. 20, a laser diode, a broadband optical modulator, and an ultrahigh-speed photodetector are required. In the case of FIG. 20, the light signals of two lasers having different wavelengths are combined to generate a THz signal corresponding to a wavelength difference between the lasers. In FIG. 20, an optical coupler refers to a semiconductor device that transmits an electrical signal using light waves to provide coupling with electrical isolation between circuits or systems, and a uni-travelling carrier photo-detector (UTC-PD) is one of photodetectors, which uses electrons as an active carrier and reduces the travel time of electrons by bandgap grading. The UTC-PD is capable of photodetection at 150 GHz or more. In FIG. 21, an erbium-doped fiber amplifier (EDFA) represents an optical fiber amplifier to which erbium is added, a photo detector (PD) represents a semiconductor device capable of converting an optical signal into an electrical signal, and OSA represents an optical sub assembly in which various optical communication functions (e.g., photoelectric conversion, electrophonic conversion, etc.) are modularized as one component, and DSO represents a digital storage oscilloscope.

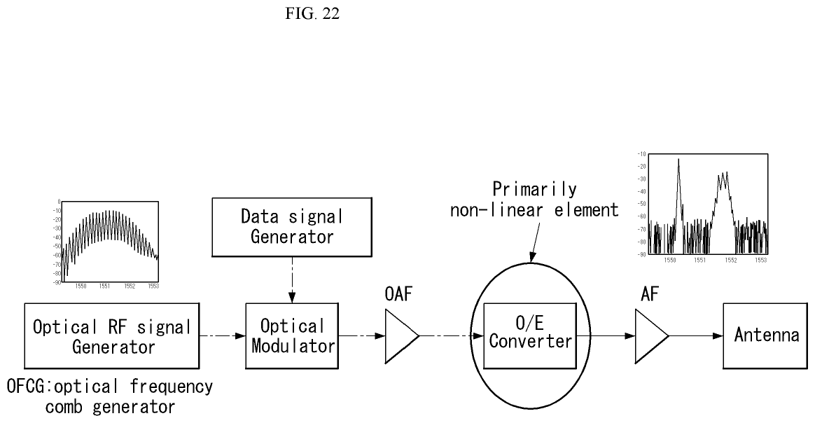

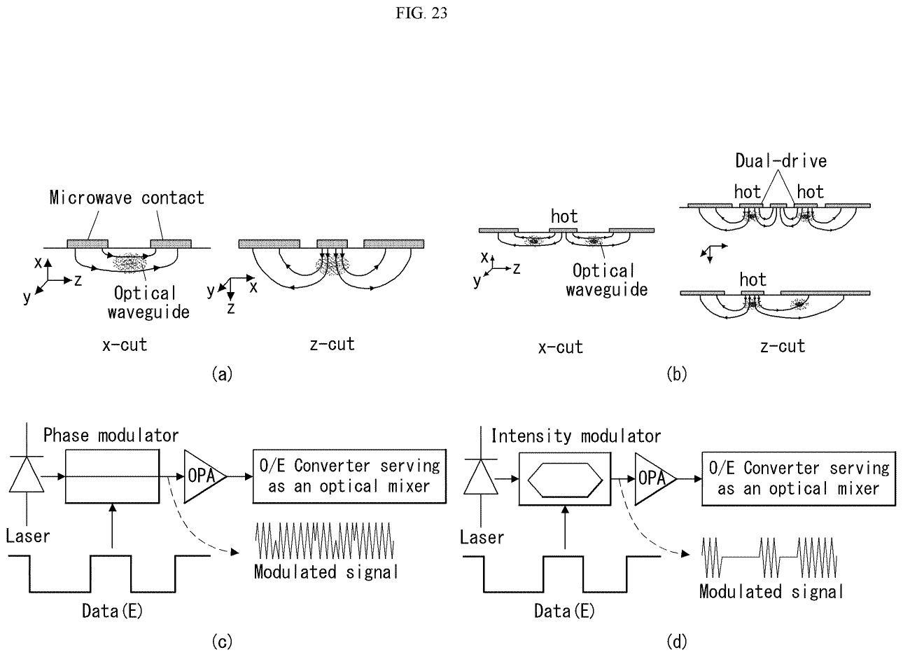

FIG. 22 illustrates a transmitter structure applicable to the present disclosure. FIG. 23 illustrates a modulator structure applicable to the present disclosure.

Referring to FIGS. 22 and 23, generally, the optical source of the laser may change the phase of a signal by passing through the optical wave guide. At this time, data is carried by changing electrical characteristics through microwave contact or the like. Thus, the optical modulator output is formed in the form of a modulated waveform. A photoelectric modulator (O/E converter) may generate THz pulses according to optical rectification operation by a nonlinear crystal, photoelectric conversion (O/E conversion) by a photoconductive antenna, and emission from a bunch of relativistic electrons. The terahertz pulse (THz pulse) generated in the above manner may have a length of a unit from femto second to pico second. The photoelectric converter (O/E converter) performs down conversion using non-linearity of the device.

Given THz spectrum usage, multiple contiguous GHz bands are likely to be used as fixed or mobile service usage for the terahertz system. According to the outdoor scenario criteria, available bandwidth may be classified based on oxygen attenuation 10\hat{ }2 dB/km in the spectrum of up to 1 THz. Accordingly, a framework in which the available bandwidth is composed of several band chunks may be considered. As an example of the framework, if the length of the terahertz pulse (THz pulse) for one carrier (carrier) is set to 50 ps, the bandwidth (BW) is about 20 GHz.

Effective down conversion from the infrared band to the terahertz band depends on how to utilize the nonlinearity of the O/E converter. That is, for down-conversion into a desired terahertz band (THz band), design of the photoelectric converter (O/E converter) having the most ideal non-linearity to move to the corresponding terahertz band (THz band) is required. If a photoelectric converter (O/E converter) which is not suitable for a target frequency band is used, there is a high possibility that an error occurs with respect to the amplitude and phase of the corresponding pulse.

In a single carrier system, a terahertz transmission/reception system may be implemented using one photoelectric converter. In a multi-carrier system, as many photoelectric converters as the number of carriers may be required, which may vary depending on the channel environment. Particularly, in the case of a multi-carrier system using multiple broadbands according to the plan related to the above-described spectrum usage, the phenomenon will be prominent. In this regard, a frame structure for the multi-carrier system can be considered. The down-frequency-converted signal based on the photoelectric converter may be transmitted in a specific resource region (e.g., a specific frame). The frequency domain of the specific resource region may include a plurality of chunks. Each chunk may be composed of at least one component carrier (CC).

Here, wireless communication technology implemented in the wireless devices 200a and 200b of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices of the present disclosure may perform communication based on LTE-M technology. In this case, as an example, the LTE-M technology may be an example of the LPWAN and may be called various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M. Additionally or alternatively, the wireless communication technology implemented in the wireless devices 200a and 200b of the present disclosure may include at least one of ZigBee, Bluetooth, and Low Power Wide Area Network (LPWAN) considering the low-power communication, and is not limited to the name described above. As an example, the ZigBee technology may generate personal area networks (PAN) associated with small/low-power digital communication based on various standards including IEEE 802.15.4, and the like, and may be called various names.

The contents described above may be applied in combination with embodiments proposed in the present disclosure to be described below or may be supplemented to clarify technical features of the embodiments proposed in the present disclosure. Embodiments to be described below are just distinguished for convenience of description and it is needless to say that some components of any one embodiment may be substituted with some components of another embodiment or may be applied in combination with each other. The present disclosure relates to a wireless transmission device, method, and procedure for transmitting with low-latency a large amount of data in a wireless communication system.

A Hybrid Automatic Repeat reQuest (HARQ) used to reduce a transmission error and increase reliability is a type in which forward error correction (FEC) and automatic repeat request (ARQ) are combined. A transmitter transmits data encoded with FEC codes. A receiver checks whether there is an error in a data transfer block by decoding a received signal, and requests retransmission from the transmitter if the error is detected. The transmitter retransmits data encoded with the FEC codes, and the receiver increases a coding gain by combining and decoding the previously received signal and a newly received signal to thereby reduce an error probability.

As a transmission rate of a communication system increases and the size of a transport block increases, a technique of dividing one transport block into a plurality of code blocks (CBs) and transmitting them has been developed to increase retransmission efficiency. The transmitter attaches a CRC to each code block as well as all the transfer blocks and transmits them, and the receiver checks the CRC for each code block and requests retransmission only for the code block in which an error occurs. Hence, the present disclosure can save radio resources required for retransmission and improve transmission efficiency. However, because it is necessary to transmit whether to perform retransmission for each code block from the receiver to the transmitter, there is a disadvantage in that radio resources required for this increase. In 5G NR, as the transmission rate increases, the size of the transport block increases, so the number of code blocks and an amount of retransmission request information further increased. Therefore, a technique has been introduced in which several code blocks are grouped together to form a code block group (CBG), and when the receiver requests retransmission on a per CBG basis, the transmitter retransmits only the requested CBG.

When there is no feedback channel to request retransmission or when retransmission is not easy, an erasure code may be used. The erasure code may be used alone, but may be used together with an LDPC code or a Turbo code, etc. to improve an error floor or reduce transmission latency due to an automatic repeat request (ARQ).

As the services supported by a wireless communication system diversify, quality of service (QoS) required for each service is diversified. In order to maintain appropriate QoS in a wireless communication environment, it is necessary to apply an appropriate code rate based on QoS and a channel environment. As the erasure code that can flexibly apply the code rate as needed, a raptor code, a sliding window random linear code (RLC), etc. may be used.

The present disclosure describes a transmission structure, HARQ-ACK (Hybrid Automatic Repeat reQuest Acknowledgement) feedback and retransmission device, method and procedure for efficiently transmitting a large amount of data with low latency by quickly recovering a transmission error occurring in a wireless communication system.

As the number of services requiring real-time transmission of a large amount of data, such as XR (extended Reality), is expected to increase, the importance of low-latency and ultra-high-speed wireless transmission technology is increasing. In particular, video data such as XR is generated in a large amount at once in each frame, and the quality of the service can be guaranteed only when the entire data corresponding to one frame is transmitted within a set time. The technology for efficiently transmitting a large amount of data in a short period of time may include a technology for increasing spectral efficiency by minimizing the transmission of control information incidentally required for data transmission and for quickly and efficiently recovering from errors that occur during transmission.

If the total amount of data to be transmitted is large and cannot be transmitted through only one shared channel (e.g., PDSCH, PUSCH, etc.), the data may be transmitted across multiple shared channels. In the wireless communication system such as LTE and NR, PDCCH resources for transmitting downlink control information (DCI) are required to schedule each shared channel. Multi-slot scheduling technology, which schedules multiple shared channels via one DCI, can increase the spectral efficiency by reducing the use of PDCCH resources when scheduling multiple shared channels.

In order to use the multi-slot scheduling technology, the transmitter must have a sufficient amount of data ready to be transmitted through the scheduled multiple shared channels. Otherwise, some of the shared channels may go unused and be wasted. Generally, the transmitter of the wireless communication system is not a data generator itself, but rather receives and transmits data generated by other systems. The data may be divided into multiple packets and transmitted to the transmitter via another wired or wireless communication network. The multiple packets may arrive at the transmitter at different times in a process of transmitting the packets via the communication network due to processing delay at each communication node, a difference in transmission paths, and a recovery from transmission errors. Therefore, it may take some time for all data packets to be collected, and the time may delay a transmission start time of the transmitter. If there is a set deadline for transmission to be completed, a delay in the transmission start time reduces the allowed time until the transmission is completed. This reduces an occasion for HARQ-ACK feedback and retransmission in the event of a transmission error, which may increase the possibility of transmission failure.

In the wireless communication system, the transmission error may occur due to various factors, such as fading of a wireless channel, interference due to a contiguous cell signal, and preemption of URLLC data during eMBB data transmission, in addition to white noise (AWGN). Some of these factors require retransmission by generating a burst error that is difficult to recover by only channel decoding, such as the LDPC code and the Turbo code, which may lead to an increase in transmission latency. In addition, if all the transport blocks are retransmitted whenever there is an error, the size of the transport block increases, and thus radio resources required for retransmission increase. Hence, efficiency may decrease.

A physical layer interleaver may be used to reduce the generation of retransmission due to the unrecoverable burst error. The interleaver can reduce the probability of the transmission error by making the burst error into a random error and increasing the possibility that the error can be recovered by channel decoding. However, in order to increase a performance gain, a large interleaver buffer has to be used, which increases a processing time of a transceiver and may add another kind of transmission latency.

The problem in which efficiency is reduced due to retransmission of all the transport blocks whenever there is a transmission error can be partially improved by code block group-based retransmission. The code block group-based retransmission can reduce the required radio resources because only a code block group with a code block, in which the error occurs, is retransmitted. However, when the transmission error is distributed to a plurality of code block groups, the number of code block groups to be retransmitted increases and the efficiency may be reduced. Further, since each code block group requires an uplink HARQ-ACK feedback bit and an information (CBG transmission information (CBGTI)) bit notifying whether to retransmit based on downlink control information (DCI), there is a disadvantage in that the number of HARQ-ACK feedback bits and the number of DCI bits increase.

The present disclosure describes a wireless transmission device, method and procedure that can reduce transmission delay by reducing the probability of retransmission using an erasure code when transmitting a large amount of data through multiple shared channels scheduled via one DCI, and, when retransmission is inevitably required, can reduce transmission delay through preemptive HARQ-ACK feedback while reducing radio resources required for retransmission and the number of HARQ-ACK feedback and DCI bits.

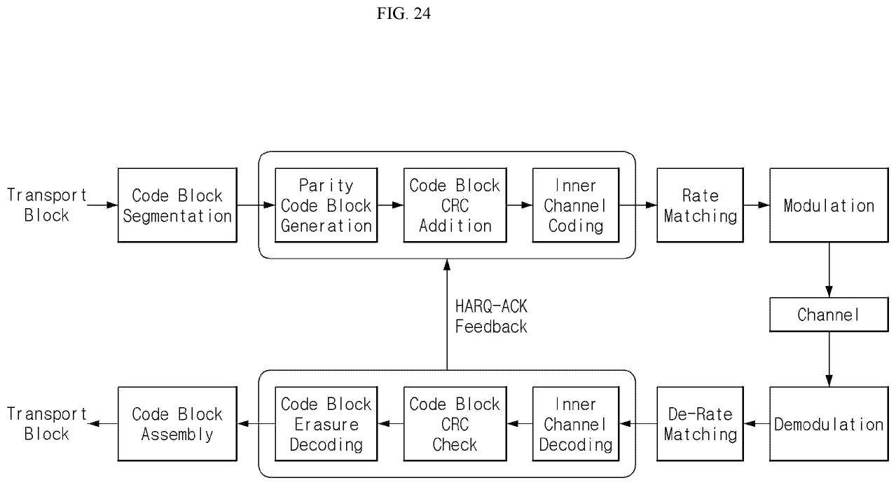

FIG. 24 is a conceptual diagram illustrating an embodiment of a procedure of transmitting by applying an internal channel code after applying an erasure code to a plurality of code blocks in a system applicable to the present disclosure.

The present disclosure is described focusing on a systematic erasure code. However, the present disclosure is not limited only to the systematic erasure code and can be applied to a non-systematic erasure code. Further, the present disclosure is described focusing on an optimal erasure code that requires k error-free data and parity symbols in order to recover k data symbols including a symbol with error. However, the present disclosure can also be applied to a sub-optimal/near-optimal erasure code that requires k or slightly more error-free data and parity symbols such as Raptor code.

The present disclosure can lower a retransmission probability and reduce transmission latency using Reed-Solomon (RS) code, Raptor code, sliding window random linear code, etc. together with a channel code, such as an LDPC code or a turbo code, as an external erasure code. FIG. 23 is an example of a system transmitting by applying an internal channel code after applying an erasure code to a plurality of code blocks. As the internal channel code, the LDPC code, the turbo code, a polar code, and the like may be used. A transmitter may divide a transfer block into a plurality of data code blocks (DCB) and perform erasure encoding between the code blocks to generate one or more parity code blocks (PCBs). Each code block may be transmitted through internal channel coding after CRC is added, rate matching, modulation, etc.

A receiver may check CRC for each code block after performing demodulation, de-rate matching, and internal channel coding on a received signal, and may check whether there is an error. If there is an error in at least one data code block, and a sufficient number of code blocks including both the data code blocks and the parity code blocks to perform erasure decoding are received without error, the receiver may perform erasure decoding between the code blocks to recover a residual transmission error. If there is a data code block with error even after the erasure decoding, the receiver may request retransmission.

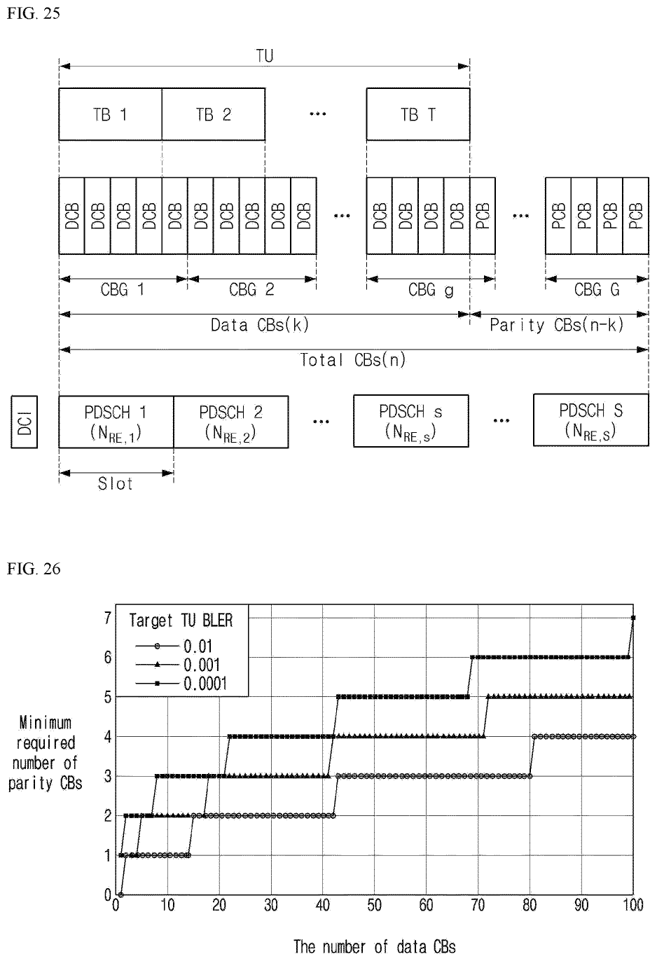

FIG. 25 is a conceptual diagram illustrating a method of transmitting and receiving data in a system applicable to the present disclosure.

FIG. 25 is a conceptual diagram illustrating an example where the system of FIG. 24 is extended to create one or more transport blocks from a transmission unit (TU) including data, that a transmitting end intends to transmit, and transmit them through multiple shared channels scheduled via one downlink control information (DCI).

Referring to FIG. 25, the transmission unit (TU) may include multiple transport blocks (TB 1 to TB T), and each transport block may include one or more DCBs. The transmitting end may generate one or more PCBs based on the one or more DCBs. The transmitting end may transmit the one or more DCBs and the one or more PCBs to a receiving end.

The receiving end may receive the one or more DCBs and the one or more PCBs from the transmitting end. If an error occurs in at least one of the one or more DCBs during transmission, the receiving end may perform an external erasure decoding based on DCB received without error among the one or more DCBs and the one or more PCBs to recover the DCBs in which the error has occurred. In this case, the receiving end may reduce transmission delay by recovering DCB, which is not recovered based on the internal channel decoding among the DCBs in which the error has occurred, based on external channel decoding.

If there are DCBs that cannot be recovered when the receiving end performs an external erasure decoding on the DCBs in which the error has occurred, retransmission of the DCBs may be required. The transmitting end may perform retransmission on the receiving end in units of code block group (CBG). The CBG may include one or more DCBs (in the case of CBGs 1 and 2 in FIG. 25), or one or more PCBs (in the case of CBG G in FIG. 25), or one or more DCBs and one or more PCBs (in the case of CBG g in FIG. 25). Therefore, retransmission efficiency can be increased.

The receiving end may receive a radio resource control (RRC) message and a MAC control element (CE) from the transmitting end. The receiving end may receive and obtain configuration information based on the RRC message and the MAC CE. The receiving end may receive DCI from the transmitting end. The receiving end may obtain scheduling information from the DCI. The receiving end may acquire information on a size of a code block, the total number of code blocks, the number of DCBs and the number of PCBs, the number of transport blocks and a size of each transport block, the entire size of a transmission unit, the number of CBGs, and the number of code blocks per CBG, based on the configuration information and the scheduling information.

The receiving end may acquire information on a size of a code block and the total number of code blocks based on a Modulation and Coding Set (MCS) of each of multiple shared channels, the number of resource elements (REs), the number of transmission layers, and a maximum quantization unit. The receiving end may obtain a code rate and modulation order from the MCS of each of the multiple shared channels. The receiving end may obtain the number of bits based on the code rate, the modulation order, the number of resource units, and the number of transmission layers. Here, the number of bits may be the number of bits transmitted through all the shared channels.

If the number of transmission layers of all the shared channels is the same, the number of bits may be expressed as in the following Equation 1.

$${N}_{i𝔫fo} = {\sum }_{s = 1}^{S} {R}_{s} {Q}_{m , s} {N}_{RE , s} v \qquad [ Equation 1 ]$$

In Equation 1, N_{info} may be the number of bits transmitted through all the shared channels, Rₛ may be the code rate, Q_{m,s} may be the modulation order, N_{RE,S} may be the number of resource units, and v may be the number of transmission layers.

If the MCSs of all the shared channels are the same, the number of bits may be expressed as in the following Equation 2.

$${N}_{info} = R {Q}_{m} v {\sum }_{s = 1}^{S} {N}_{RE , s} \qquad [ Equation 2 ]$$

In Equation 2, R may be the code rate when the MCSs of all the shared channels are the same, and Qₘ may be the modulation order when the MCSs of all the shared channels are the same.

The receiving end may perform quantization on the number of bits. The receiving end may perform quantization on the number of bits based on Equations 3 and 4.

$${N}_{info}^{′} = {2}^{x} \times round ( \frac{{N}_{info}}{{2}^{x}} ) \qquad [ Equation 3 ]$$

$$x = ⌊ {log}_{2} {N}_{info} ⌋ - {x}_{b i a s} \qquad [ Equation 4 ]$$

In Equations 3 and 4,

$${N}_{info}^{′}$$

may be the number of bits on which the quantization is performed. x_{bias} may be a bias value of x. In an embodiment, the receiving end may obtain the bias value of x based on Equation 5.

$${x}_{bias} = {x}_{bias , min} + ⌊ \frac{{log}_{2} {N}_{info}}{{x}_{adjust}} ⌋ \qquad [ Equation 5 ]$$

In Equation 5, x_{bias,min} may be a minimum value of the bias value of x, and x_{adjust} may be an adjustment value of x. Here, x_{bias,min} and x_{adjust} may be preset values between the transmitting end and the receiving end. Alternatively, the receiving end may receive x_{bias,min} and x_{adjust} from the transmitting end via the RRC message or the MAC CE. According to Equation 5, the receiving end may obtain an integer value proportional to log₂ N_{info} as x_{bias}.

In another embodiment, the receiving end may determine the bias value of x based on the number of bits. The receiving end may obtain multiple sections based on the number of bits, and set a different bias value of x for each section. For example, if the number of bits is less than or equal to a possible maximum value in one slot, the receiving end may set the bias value of x to 5, and set the bias value of x to 6 otherwise. Accordingly, the receiving end may control a quantization step and the resulting change in the code block size and the total number of code blocks.

The receiving end may obtain the total number of code blocks based on the number of bits, on which the quantization is performed, and a maximum size of the code block. In the NR standard, the maximum size of the code block may be determined based on a LDPC base graph. The LDPC base graph may include LDPC base graph 1 or LDPC base graph 2. The receiving end may obtain the total number of code blocks based on Equation 6 or 7.

$$n = ⌈ \frac{{N}_{info}^{′}}{{K}_{CB , BG 1} - {L}_{CRC , CB}} ⌉ \qquad [ Equation 6 ]$$

$$n = ⌈ \frac{{N}_{info}^{′}}{{K}_{CB , BG 2} - {L}_{CRC , CB}} ⌉ \qquad [ Equation 7 ]$$

In Equation 6 and 7, n may be the total number of code blocks,

$${N}_{info}^{′}$$

may be the number of bits on which the quantization is performed, K_{CB,BG1} may be a maximum size of the code block including CRC in case of using the LDPC base graph 1, K_{CB,BG2} may be a maximum size of the code block including CRC in case of using the LDPC base graph 2, and L_{CRC,CB} may be a length of CRC. The receiving end may obtain the size of the code block excluding the CRC from all the code blocks based on Equations 8 and 9.

$$CBS = 8 \times ⌈ \frac{{N}_{info}^{′}}{8 \times n} ⌉ \qquad [ Equation 8 ]$$

$${K}_{CB} = CBS + {L}_{CRC , CB} \qquad [ Equation 9 ]$$

In Equations 8 and 9, CBS may be a size of the code block excluding the CRC from all the code blocks, and K_{CB} may be a size of the code block including the CRC.

The receiving end may obtain the number of DCBs and the number of PCBs from the total number of code blocks.

The BLER of the maximum transmission unit may be expressed as in the following Equation 10.

$${BLER}_{T U} = 1 - {\sum }_{i = 0}^{n - k} ( \begin{matrix}n \\ i\end{matrix} ) {{p}^{i} ( 1 - p )}^{n - i} \qquad [ Equation 10 ]$$

In Equation 10, BLER_{TU} may be the BLER of the maximum transmission unit, p may be the BLER of the code block, n may be the number of DCBs, and (n−k) may be the number of PCBs. Referring to Equation 10, if n is less than k, BLER_{TU} may be 1, and the receiving end may not recover a residual error in the DCB based on an external erasure code. The minimum number of PCBs required for the receiving end to achieve the target BLER of the transmission unit may vary depending on the number of DCBs and the BLER of the code block.

FIG. 26 is a conceptual diagram illustrating the minimum number of PCBs required to achieve a target BLER of a transmission unit according to an embodiment of the present disclosure.

FIG. 26 is a conceptual diagram illustrating the minimum number of PCBs required to achieve a target BLER of a transmission unit per the number of DCBs when BLER of a code block is 0.01. Referring to FIG. 26, the receiving end may determine the maximum number of DCBs that can achieve the target BLER of a transmission unit based on the number of PCBs. Here, the total number of transport blocks may be a sum of the number of DCBs and the number of PCBs, and the receiving end may determine the maximum number of code blocks that can achieve the target BLER of the transmission unit per the number of PCBs.

For example, the receiving end may obtain the maximum number of DCBs and the maximum number of all the code blocks that can achieve the target BLER of the target transmission unit based on the number of PCBs, based on Table 6 below.

TABLE 6

| | Target TU BLER = 0.01 | | Target TU BLER = 0.001 | | Target TU BLER = 0.0001 | |
|---|---|---|---|---|---|---|
| n-k | nₘₐₓ | kₘₐₓ | nₘₐₓ | kₘₐₓ | nₘₐₓ | kₘₐₓ |
| 1 | 15 | 14 | 5 | 4 | 2 | 1 |
| 2 | 44 | 42 | 19 | 17 | 9 | 7 |
| 3 | 83 | 80 | 44 | 41 | 24 | 21 |
| 4 | 129 | 125 | 75 | 71 | 46 | 42 |
| 5 | 180 | 175 | 112 | 107 | 73 | 68 |
| 6 | 234 | 228 | 154 | 148 | 105 | 99 |
| 7 | 292 | 285 | 199 | 192 | 141 | 134 |
| 8 | 353 | 345 | 248 | 240 | 180 | 172 |
| 9 | 415 | 406 | 299 | 290 | 223 | 214 |
| 10 | 479 | 469 | 352 | 342 | 268 | 258 |

Table 6 may be generated based on Equation 10. In Table 6, n−k may be the number of PCBs, kₘₐₓ may be the maximum number of DCBs, and nₘₐₓ may be the maximum number of all the code blocks corresponding to kₘₐₓ. For example, in order for the receiving end to achieve a BLER of a transport block of 0.001 or less based on two PCBs, the maximum number of DCBs may be 17, and the maximum number of code blocks may be 19, which is a sum of 17 and 2.

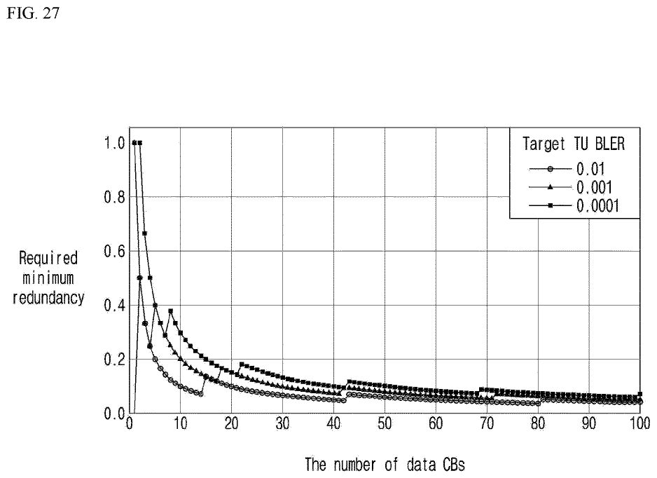

FIG. 27 is a conceptual diagram illustrating a redundancy ratio according to an embodiment of the present disclosure.

FIG. 27 is a conceptual diagram illustrating a redundancy ratio of the number of PCBs divided by the number of DCBs. Here, the number of PCBs may be the number of PCBs required per the number of DCBs to achieve a target code block BLER.

Referring to FIG. 27, it can be seen that the redundancy ratio increases as the number of code blocks to be transmitted decreases. This means that when the number of DCBs is small, relatively more radio resources shall be used to transmit the PCB, which may result in a reduction in transmission efficiency. Therefore, when the number of code blocks is small, it may be more efficient for the receiving end to not use an external erasure code to recover the DCBs. Hence, the transmitting end can define the minimum number of DCBs required to transmit the PCB during first transmission. In other words, the transmitting end can transmit the PCB only if the number of DCBs required during the first transmission is greater than or equal to the minimum number of DCBs.

The receiving end may obtain the number of DCBs and the number of PCBs based on Table 6 and the minimum number k_{OC,min} of DCBs required to transmit the PCB during the first transmission. The receiving end may obtain the number of DCBs and the number of PCBs from the total number of code blocks. This is described in detail as follows.

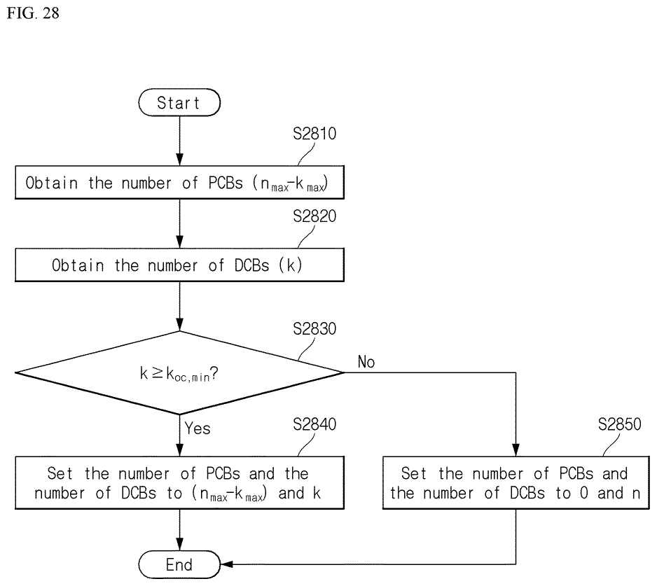

FIG. 28 is a flowchart illustrating a method of obtaining the number of DCBs and the number of PCBs according to an embodiment of the present disclosure.

Referring to FIG. 28, a receiving end may obtain the number of PCBs, in S2810. The receiving end may obtain the smallest nₘₐₓ value among values greater than or equal to the total number of code blocks (n) from Table 6. The receiving end may obtain kₘₐₓ value corresponding to the obtained nₘₐₓ. The receiving end may obtain the number of PCBs (nₘₐₓ−kₘₐₓ) by subtracting the corresponding kₘₐₓ value from the obtained nₘₐₓ. Alternatively, the receiving end may directly obtain the number of PCBs (n−k) corresponding to the obtained nₘₐₓ from a first column of Table 6.

The receiving end may obtain the number of DCBs, in S2820. The receiving end may obtain the number of DCBs (k) by subtracting the number of PCBs (nₘₐₓ−kₘₐₓ) obtained in S2810 from the total number of code blocks (n). The number of DCBs (k) may be n−(nₘₐₓ−kₘₐₓ).

The receiving end may determine whether the number of DCBs (k) is greater than or equal to k_{OC,min}, in S2830. If the number of DCBs (k) is greater than or equal to k_{OC,min}. (Yes in S2830), the receiving end may determine that an external erasure code has been applied and may set the number of DCBs and the number of PCBs to the number of PCBs (nₘₐₓ−kₘₐₓ) and the number of DCBs (k) obtained in S2810 and S2820, in S2840.

If the number of DCBs (k) is less than k_{OC,min} (No in S2830), the receiving end may set the number of PCBs to 0 and set the number of DCBs to be equal to the total number of code blocks (n), in S2850.

The receiving end may obtain the number of transport blocks based on the number of DCBs. The receiving end may obtain the number of transport blocks based on Equation 11.

$$T = ⌈ \frac{CBS \times k}{{TBS}_{max} + {L}_{CRC , TB}} ⌉ \qquad [ Equation 11 ]$$

In Equation 11, TBSₘₐₓ may be predetermined between the transmitting end and the receiving end as a maximum size of a transport block not including CRC, or may be received by the receiving end from the transmitting end via an RRC message or MAC CE, etc.

Each transport block may be transmitted through one or more DCBs, and the receiving end may obtain the number of DCBs transmitting each transport block based on Equation 12 and 13.

$$r = k mod T \qquad [ Equation 12 ]$$

$${k}_{t} = \{ \begin{matrix}⌈ \frac{k}{T} ⌉ , & 1 \leq t \leq r \\ ⌊ \frac{k}{T} ⌋ , & r < t \leq T\end{matrix} \qquad [ Equation 13 ]$$

In Equation 12 and 13, Kt may be the number of DCBs transmitting each transport block. The receiving end may obtain the size of each transport block including the CRC and the size of each transport block excluding the CRC based on Equations 14 and 15.

$${K}_{TB , t} = CBS \times {k}_{t} \qquad [ Equation 14 ]$$

$${TBS}_{t} = {K}_{TB , t} - {L}_{CRC , TB} \qquad [ Equation 15 ]$$

In Equations 14 and 15, K_{TB,t} may be the size of each transport block including the CRC, and TBSₜ may be the size of each transport block excluding the CRC. The receiving end may obtain the entire size of the transmission unit based on Equation 16.

$$TUS = {\sum }_{t = 1}^{T} {TBS}_{t} \qquad [ Equation 16 ]$$

In Equation 16, TUS may be the total size of the transmission unit. Referring to Equation 16, the receiving end may obtain the total size of the transmission unit by adding the sizes of the respective transport blocks excluding the CRC.

The receiving end may obtain the number of CBGs and the number of code blocks per each CBG based on Equations 17 to 19.

$$G = min ( max ( 1 , ⌊ \frac{n}{{n}_{CBG , min}} ⌋ ) , {N}_{CBG} ) \qquad [ Equation 17 ]$$

$$r = n mod G \qquad [ Equation 18 ]$$

$${n}_{g} = \{ \begin{matrix}⌈ \frac{n}{G} ⌉ , & 1 \leq g \leq r \\ ⌊ \frac{n}{G} ⌋ , & r < g \leq G\end{matrix} \qquad [ Equation 19 ]$$

In Equations 17 to 19, G may be the number of CBGs, n_{CBG,min} may be the minimum number of code blocks per CBG, N_{CBG} may be the maximum number of CBGs, and n_{g} may be the number of code blocks per each CBG. Here, n_{CBG,min} and N_{CBG} may be predetermined between the transmitting end and the receiving end, or may be received by the receiving end from the transmitting end via an RRC message or MAC CE, etc.

Referring to Equations 17 to 19, the number of CBGs may be greater than or equal to the minimum number of code blocks per CBG. This is to prevent the retransmission efficiency from being reduced due to the very small number of code blocks belonging to each CBG when the receiving end intends to retransmit a specific CBG to repair errors in DCBs belonging to other CBGs.

### HARQ-ACK Feedback and the Corresponding Retransmission Method

When a transmitting end initially transmits data, a receiving end may receive the data and check whether there is a transmission error. If a transmission error exists in DCB, the receiving end may recover the transmission error of the DCB based on internal channel decoding and external erasure decoding. If the receiving end cannot recover all the transmission errors of the DCB based on the internal channel decoding and the external erasure decoding, the receiving end may request retransmission of the data from the transmitting end.

The receiving end may transmit, to the transmitting end, whether to retransmit data and a retransmission method by feeding back HARQ-ACK values to the transmitting end based on Table 7.

TABLE 7

| | Number of | |
|---|---|---|
| HARQ-ACK | HARQ-ACK | |
| Type | values | Meaning |
| NACK | 0 | There is an unrecoverable error; |
| | | Retransmission request for all CBGs |
| NACK-CBG | N_{CBG} | There is an unrecoverable error; |
| | | CBG index information to be |
| | | retransmitted |
| NACK-PCB | 2^{^{N}}^{HARQ-ACK} − | There is an unrecoverable error; |
| | (2 + N_{CBG}) | Request for additional transmission |
| | | of the number of PCBs calculated in |
| | | a pre-arranged manner, not included |
| | | in first transmission (the number of |
| | | PCBs may be defined in relation to |
| | | the number of CBGs and the number of |
| | | code blocks in first transmission) |
| ACK | 1 | The entire TU has received without |
| | | error or error is recovered |

In Table 7, N_{CBG} may be the maximum number of CBGs, and N_{HARQ-ACK} may be the number of bits of HARQ-ACK feedback.

Referring to Table 7, if the receiving end recovers all the errors of the DCB based on the internal channel decoding and the external erasure decoding, the receiving end may transmit ACK to the transmitting end. If the receiving end cannot recover all the errors of the DCB based on the internal channel decoding and the external erasure decoding, the receiving end may transmit, to the transmitting end, NACK including a retransmission method which is determined to be most efficient. The receiving end may transmit the NACK to the transmitting end in the following three cases.

Case 1) If all code blocks within one CBG are recovered by the retransmission and the inner channel decoding, and errors in all DCBs of a transmission unit are recovered by the external erasure decoding, the receiving end may transmit index information of the corresponding CBG to the transmitting end as a HARQ-ACK value.

Case 2) If the receiving end recover errors in all the DCBs by additionally receiving a predetermined number of PCBs without errors, the receiving end may transmit a HARQ-ACK value requesting additional PCB transmission to the transmitting end. Here, the predetermined number of PCBs may be the number of PCBs that is greater than or equal to the number required to recover the errors of all the DCBs among preset numbers between the transmitting end and the receiving end. The predetermined number of PCBs may be a smallest number of PCBs that is greater than or equal to the number required to recover the errors of all the DCBs. In addition, the number of PCBs corresponding to the HARQ-ACK value may be defined in relation to the number of CBGs and the number of code blocks in the first transmission.

Case 3) If it does not correspond to the case 1 and the case 2, the transmitting end may transmit a HARQ-ACK value requesting retransmission of all the CBGs to the transmitting end.

For example, if the maximum number of CBGs (N_{CBG}) is 4, and the value of N_{HARQ-ACK} is 3, the HARQ-ACK value transmitted by the receiving end to the transmitting end based on the HARQ-ACK type may be as shown in Table 8 below.

TABLE 8

| HARQ-ACK | HARQ-ACK | |
|---|---|---|
| Type | value(s) | Meaning |
| NACK | 0 | Retransmission request for all CBGs |
| NACK-CBG | 1~4 | CBG index to be retransmitted |
| NACK-PCB | 5 | Request for additional PCB transmission not |
| | | included in first transmission. |
| | | The number of PCBs is the number of CBGs |
| | | in first transmission, i.e., G. |
| NACK-PCB | 6 | Request for additional PCB transmission not |
| | | included in first transmission. |
| | | The number of PCBs is the number of CBGs |
| | | in first transmission, i.e., the smallest integer |
| | | greater than or equal to 1.5 times G. |
| ACK | 7 | The entire TU has received without error or |
| | | error is recovered |

The transmitting end may receive feedback on the HARQ-ACK value from the receiving end. In an embodiment, the transmitting end may perform retransmission based on the HARQ-ACK value. In another embodiment, the transmitting end may perform retransmission in a method independent of the HARQ-ACK value. For example, even if the transmitting end receives feedback on the retransmission of a specific CBG from the receiving end (e.g., if the transmitting end receives feedback on the HARQ-ACK value of 1 to 4), the transmitting end may retransmit all CBGs or transmit a greater number of PCBs than the code blocks included in the feedback CBGs so as to ensure higher reliability.

The transmitting end may transmit actually transmitted Transmitting Code Block Information (TCBI) to the receiving end via separate signaling. The transmitting end may transmit information on the actually transmitted code blocks to the receiving end via downlink control information. The actually transmitted information on the code blocks may be as shown in Table 9.

TABLE 9

| TCBI | Number of | |
|---|---|---|
| Type | TCBI values | Meaning |
| ALL | 1 | First transmission or retransmission of |
| | | all CBGs |
| CBG | N_{CBG} | CBG index information to be retransmitted |
| PCB | 2^{^{N}}^{HARQ-ACK} − | Additional PCBs of the number calculated |
| | (2 + N_{CBG}) | in a pre-arranged manner, not included in |
| | | first transmission (the number of PCBs |
| | | may be defined in relation to the number |
| | | of CBGs and the number of CBs in first |
| | | transmission) |
| RSVD | 1 | Reserved |

In Table 9, N_{CBG} and N_{HARQ-ACK} may be the maximum number of CBGs and the number of bits of HARQ-ACK, respectively.

For example, if the maximum number of CBGs (N_{CBG}) is 4, the TCBI value transmitted by the transmitting end to the receiving end based on the type of TCBI may be as shown in Table 10 below.

TABLE 10

| TCBI | TCBI | |
|---|---|---|
| Type | value(s) | Meaning |
| ALL | 0 | First transmission or retransmission of all CBGs |
| CBG | 1~4 | CBG index information to be retransmitted |
| PCB | 5 | Transmission of additional PCBs not included in |
| | | first transmission |
| | | The number of PCBs is the number of CBGs in first |
| | | transmission, i.e., G. |
| PCB | 6 | Retransmission of additional PCBs not included in |
| | | first transmission. |
| | | The number of PCBs is the number of CBGs in first |
| | | transmission, i.e., the smallest integer greater |
| | | than or equal to 1.5 times G. |
| RSVD | 7 | Reserved |

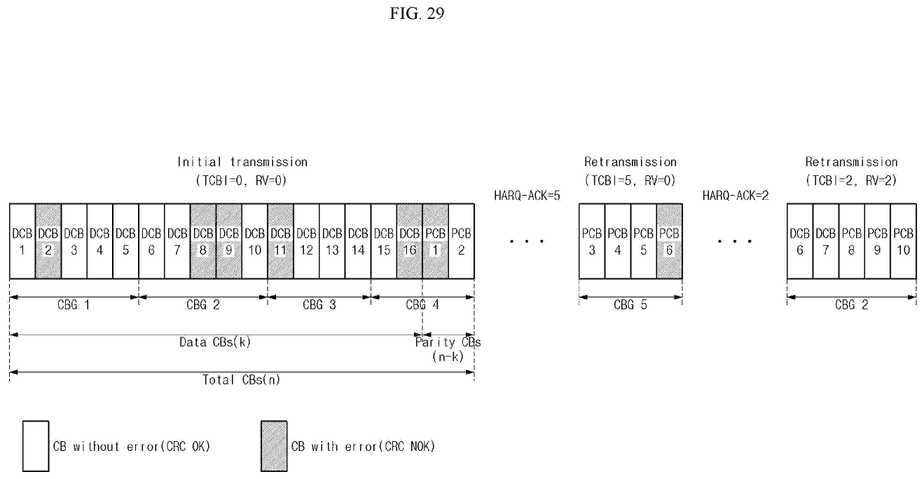

FIG. 29 is a conceptual diagram illustrating HARQ-ACK feedback and retransmission according to an embodiment of the present disclosure.

FIG. 29 is a conceptual diagram, when a transmitting end divides one transmission unit into 16 DCBs and adds two PCBs to first transmit four CBGs to a receiving end, illustrating HARQ-ACK feedback of the receiving end and retransmission of the transmitting end when errors occur in 6 code blocks of 18 code blocks and no error occurs in 12 code blocks. In FIG. 29, HARQ-ACK values and TCBI values may be shown as in Tables 8 and 10.

Referring to FIG. 29, if the receiving end receives the remaining 12 code blocks (DCB 1, DCB 3 to DCB 7, DCB 10, DCB 12 to DCB 15, and PCB 2) without error among the code blocks (DCB 1 to DCB 16 and PCB 1 to PCB 2) first transmitted by the transmitting end, and an error occurs in the remaining 6 code blocks (DCB 2, DCB 8, DCB 9, DCB 11, DCB 16, and PCB 1), the receiving end may need 16 error-free code blocks to recover all the DCBs. Therefore, in order for the receiving end to recover all the DCBs, it is necessary to secure the 12 code blocks received without error and an additional 4 error-free code blocks.

For example, if the transmitting end retransmits any one of CBG 1 to CBG 4 to the receiving end and all code blocks of the retransmitted CBG are recovered, the number of code blocks that the receiving end can additionally secure may be 1, 2, 1, and 2, respectively, all of which may be less than 4. The receiving end may request transmission of four additional consecutive PCBs without requesting the transmitting end to retransmit a specific CBG. That is, the receiving end may transmit the HARQ-ACK value of 5 to the transmitting end instead of feeding back the HARQ-ACK values of 1 to 4 to the transmitting end. The transmitting end may receive the HARQ-ACK value of 5 as feedback and retransmit four new PCBs, PCB 3 to PCB 6, to the receiving end.

If an error occurs in one PCB (PCB 6) of the four additionally transmitted PCBs (PCBs 3 to 6) via CBG 5, the receiving end can secure only three code blocks of the four error-free code blocks required to recover all the DCBs. In this case, the receiving end does not need to re-secure the four error-free code blocks, but needs to re-secure one error-free code block.

In this case, the receiving end may request the transmitting end to retransmit one CBG among CBG 1 to CBG 5. For example, the receiving end may request the transmitting end to retransmit the CBG 2 to secure at most two error-free DCBs. The receiving end may transmit the HARQ-ACK value of 2 to the transmitting end. The transmitting end may receive 2 as the HARQ-ACK value from the receiving end and retransmit the CBG 2 to the receiving end.

The receiving end may receive the CBG 2. The receiving end may recover DCB 8 and DCB 9 of the CBG 2. Therefore, the receiving end may obtain 17 error-free code blocks. The receiving end may recover DCB 2, DCB 11, and DCB 16 through the external erasure decoding.

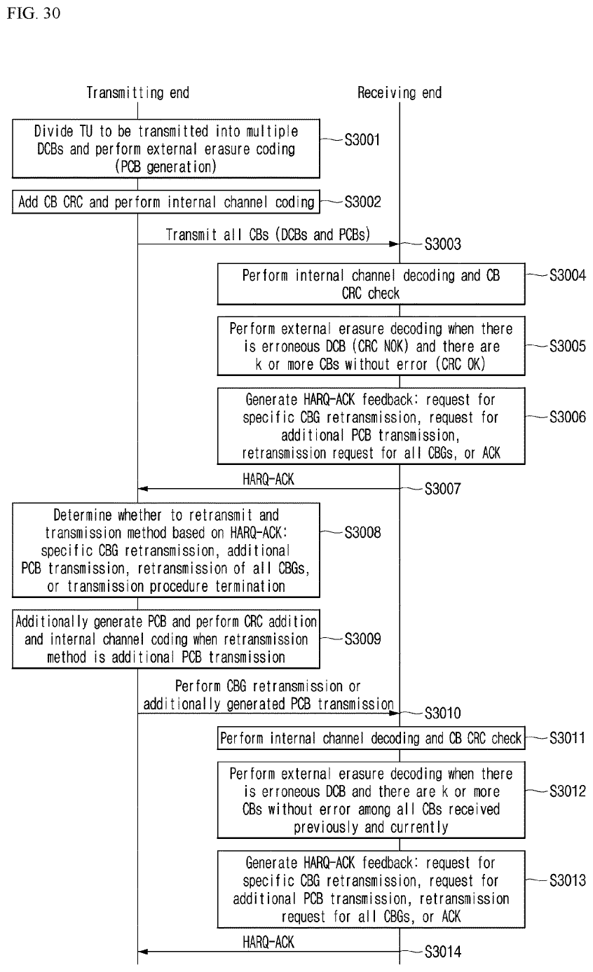

FIG. 30 is a flowchart illustrating a method for a receiving end to determine a retransmission method according to an embodiment of the present disclosure.

Referring to FIG. 30, the transmitting end may divide a TU to be transmitted into multiple DCBs, perform external erasure coding, and generate a PCB, in S3001. The transmitting end may add a CB CRC and perform internal channel coding, in S3002. The transmitting end may transmit all CBs to the receiving end, in S3003. Here, all the CBs may include a DCB and a PCB.

The receiving end may receive all the CBs from the transmitting end, in S3003. The receiving end may perform the internal channel decoding and CB CRC check based on all the CBs, in S3004. The receiving end may perform the external erasure decoding if there is an erroneous DCB (CRC not OK) and there are k or more CBs without errors (CRC OK), in S3005. The receiving end may generate first HARQ-ACK feedback, in S3006. The first HARQ-ACK feedback may include information on a retransmission method or an ACK. The retransmission method may include a request for a specific CBG retransmission, a request for an additional PCB transmission, or a retransmission request for all the CBGs. The receiving end may transmit the first HARQ-ACK feedback to the transmitting end, in S3007.

The transmitting end may receive the first HARQ-ACK feedback from the receiving end, in S3007. The transmitting end may determine whether to retransmit and a transmission method based on the first HARQ-ACK feedback, in S3008. Here, the retransmission method may be any one of specific CBG retransmission, additional PCB transmission, and retransmission of all the CBGs. If the retransmission method is the additional PCB transmission, the transmitting end may additionally generate a PCB and perform CRC addition and the internal channel coding, in S3009. The transmitting end may perform the CBG retransmission or transmission of the additionally generated PCB to the receiving end, in S3010.

The receiving end may perform the CBG retransmission or the reception of additionally generated PCB from the transmitting end, in S3010. The receiving end may perform the internal channel decoding and CB CRC check, in S3011. If there is an erroneous DCB and there are k or more CBs without errors among all the CBs received in steps S3003 and S3010, the receiving end may perform the external erasure decoding, in S3012. The receiving end may generate second HARQ-ACK feedback, in S3013. The second HARQ-ACK feedback may include information on a retransmission method or an ACK. The retransmission method may include one of a specific CBG retransmission request, an additional PCB transmission request, or a retransmission request for all the CBGs. The receiving end may transmit the second HARQ-ACK feedback to the transmitting end, in S3014.

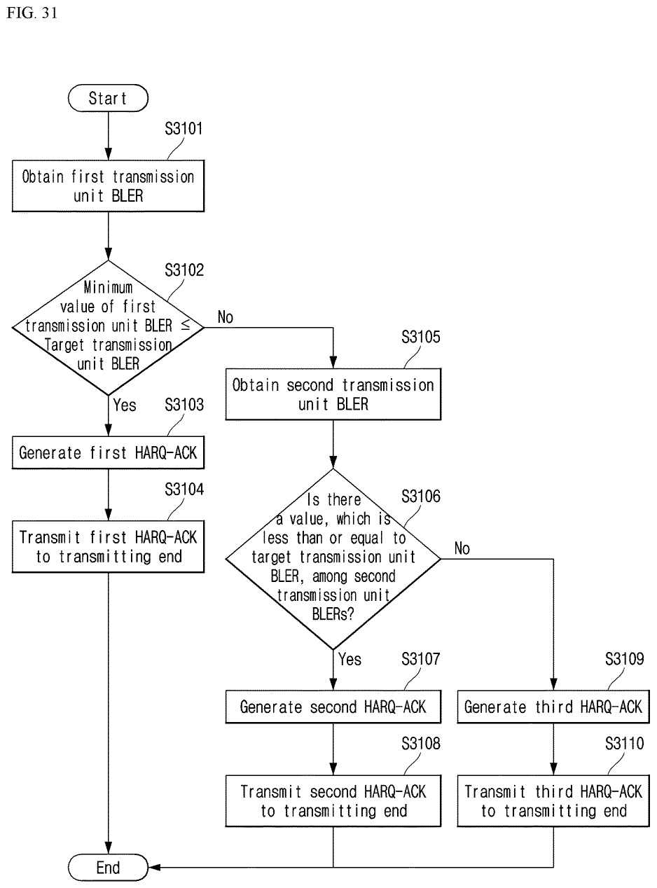

FIG. 31 is a flowchart illustrating a method of determining a retransmission method according to an embodiment of the present disclosure.

Referring to FIG. 31, the receiving end may obtain a first transmission unit BLER, in S3101. The first transmission unit BLER may be an expected transmission unit BLER when the transmitting end retransmits each CBG. The receiving end may obtain the first transmission unit BLER per CBG. The receiving end may obtain the first transmission unit BLER based on Equation 20.

$${BLER}_{TU , g} = 1 - {\sum }_{i = 0}^{( m + {e}_{g} ) - k} ( \begin{matrix}{e}_{g} \\ i\end{matrix} ) {{q}^{i} ( 1 - q )}^{{e}_{g} - i} \qquad [ Equation 20 ]$$

In Equation 20, BLER_{TU,g} may be the first transmission unit BLER, and g may be the CBG. Further, ‘m’ may be the number of all code blocks received without error before the receiving end performs step S3101. For example, referring to FIG. 29, ‘m’ may be 12 at the time the receiving end receives the first transmission from the transmitting end, and ‘m’ may be 15 at the time the receiving end receives the first retransmission. e_{g} may be the maximum number of error-free code blocks that can be additionally secured by retransmission. For example, in FIG. 29, if CBG 2 is retransmitted at the time of receiving the first transmission, up to two error-free code blocks may be additionally secured, and e_{g} may be 2. q may be an expected BLER of code blocks when a base station retransmits the CBG. q may be less than a target code block BLER in the first transmission.

The receiving end may determine whether a minimum value of the first transmission unit BLER is less than or equal to the target transmission unit BLER, in S3102. The receiving end may determine whether the minimum value among the first transmission unit BLERs obtained in step S3101 is less than or equal to the target transmission unit BLER. If the minimum value of the first transmission unit BLER is less than or equal to the target transmission unit BLER (YES in S3102), the receiving end may generate first HARQ-ACK feedback, in S3103. The first HARQ-ACK may be for requesting the transmitting end to retransmit the CBG corresponding to the minimum value of the first transmission unit BLER. The receiving end may transmit the first HARQ-ACK feedback to the transmitting end, in S3104.

If the minimum value of the first transmission unit BLER is greater than the target transmission unit BLER (NO in S3102), the receiving end may obtain second transmission unit BLERs, in S3105. The second transmission unit BLERs may be expected transmission unit BLERs when the transmitting end transmits an additional PCB. The receiving end may obtain multiple second transmission unit BLERs based on the corresponding HARQ-ACK feedback when the additional PCB is transmitted. The receiving end may obtain the second transmission unit BLERs based on Equation 21.

$${BLER}_{TU , h} = 1 - {\sum }_{i = 0}^{( m + {l}_{h} ) - k} ( \begin{matrix}{l}_{h} \\ i\end{matrix} ) {{p}_{a}^{i} ( 1 - {p}_{a} )}^{{l}_{h} - i} \qquad [ Equation 21 ]$$

In Equation 21, BLER_{TU,h} may be the second transmission unit BLER, and ‘m’ may be the number of all code blocks received without error before the receiving end performs step S3105. For example, referring to FIG. 29, ‘m’ may be 12 at the time the receiving end receives the first transmission from the transmitting end, and ‘m’ may be 15 at the time the receiving end receives the first retransmission.

lₕ may be the maximum number of error-free code blocks that the receiving end can secure when the transmitting end transmits additional PCBs. For example, referring to FIG. 29, if the transmitting end transmits four new PCBs at the time the receiving end receives the first transmission, the receiving end may additionally secure up to four error-free code blocks, and lₕ may be 4.

pₐ may be an expected BLER of code blocks when the transmitting end transmits additional PCBs. For example, pₐ may be the target code block BLER in the first transmission, or may be a value corrected based on the signal quality (SNR, etc.) of the code blocks received in the first transmission.

The receiving end may determine whether there is a value, which is less than or equal to the target transmission unit BLER, among the second transmission unit BLERs, in S3106. If there is a value, which is less than or equal to the target transmission unit BLER, among the second transmission unit BLERs (YES in S3106), the receiving end may generate second HARQ-ACK feedback, in S3107. The receiving end may select a maximum value among the second transmission unit BLERs that are less than or equal to the target transmission unit BLER. The receiving end may generate the second HARQ-ACK feedback corresponding to the selected second transmission unit BLER. The second HARQ-ACK feedback may be for requesting the transmitting end to transmit a PCB corresponding to the selected second transmission unit BLER. The receiving end may transmit the second HARQ-ACK feedback to the transmitting end, in S3108.

If there is no value, which is less than or equal to the target transmission unit BLER, among the second transmission unit BLERs (NO in S3106), the receiving end may generate third HARQ-ACK feedback, in S3109. The third HARQ-ACK may be for requesting the transmitting end to retransmit all the CBGs. The receiving end may transmit the third HARQ-ACK feedback to the transmitting end, in S3110.

### Proactive HARQ-ACK Feedback and Low-Latency Transmission Method Using Retransmission

As described above, a combination of code block-based external erasure codes and HARQ can reduce the probability of HARQ retransmission to reduce a transmission latency and can reduce radio resources required for retransmission, the number of HARQ-ACK feedback bits, and the number of DCI bits when retransmission is unavoidably necessary. However, because the HARQ-ACK feedback is performed after the first transmission is completed, there is a problem in that the transmission latency greatly increases when the retransmission is required compared to when the retransmission is not required.

The present disclosure proposes a method and procedure for reducing transmission latency by estimating the transmission unit BLER when the first transmission has been completed based on the error probability and signal quality of code blocks received at a certain time before the completion of the first transmission, and proactively performing HARQ-ACK feedback based on this estimation, thereby enabling retransmission to be performed consecutively or at the earliest possible time after the first transmission.

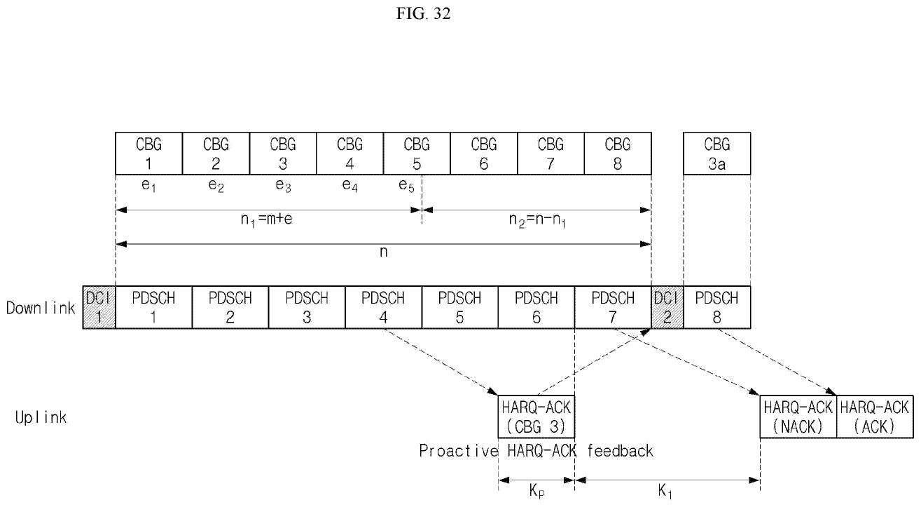

FIG. 32 is a conceptual diagram illustrating a transmission latency reduction method according to an embodiment of the present disclosure.

FIG. 32 is a conceptual diagram illustrating a case where, when a transmitting end transmits multiple CBGs, including DCBs or PCBs, via multiple PDSCHs, a receiving end proactively transmits HARQ-ACK to enable reception of a PDSCH retransmitted immediately after receiving a last PDSCH, thereby reducing the transmission latency. In this case, the receiving end may transmit HARQ-ACK feedback to the transmitting end during the first transmission.

Referring to FIG. 32, a relationship of the number of all code blocks received by the receiving end from the transmitting end, the number of all code blocks received by the receiving end from the transmitting end at the time the receiving end receives PDSCH 4, and the number of code blocks the receiving end will receive from the transmitting end after receiving PDSCH 4 may be expressed as in Equation 22.

$${n}_{2} = n - {n}_{1} \qquad [ Equation 22 ]$$

In Equation 22, n may be the number of all code blocks received by the receiving end from the transmitting end, n₁ may be the number of all code blocks received by the receiving end from the transmitting end at the time the receiving end receives PDSCH 4, and n₂ may be the number of code blocks that the receiving end will receive from the transmitting end after receiving PDSCH 4.

A relationship of the number of all code blocks received by the receiving end from the transmitting end at the time the receiving end receives PDSCH 4, the number of code blocks received without error among all code blocks received by the receiving end from the transmitting end, the number of code blocks in which an error occurs among all code blocks received by the receiving end from the transmitting end, CBG received by the receiving end from the transmitting end, and the number of code blocks in which an error occurs in CBG received by the receiving end from the transmitting end may be expressed as in the following Equations 23 and 24.

$${n}_{1} = m + e \qquad [ Equation 23 ]$$

$$e = {\sum }_{r \times CBG g} {e}_{g} \qquad [ Equation 24 ]$$

In Equations 23 and 24, m may be the number of code blocks received without error among all code blocks received by the receiving end from the transmitting end, e may be the number of code blocks in which an error occurs among all code blocks received by the receiving end from the transmitting end, CBG g may be CBG received by the receiving end from the transmitting end, and e_{g} may be the number of code blocks in which an error occurs in CBG g received by the receiving end from the transmitting end.

The receiving end may obtain an expected BLER of the transmission unit, which is the transmission unit BLER at the time when the first transmission is completed, based on the following Equation 25.

$${BLER}_{T U} = 1 - {\sum }_{j = 0}^{( n - e ) - k} ( \begin{matrix}{n}_{2} \\ j\end{matrix} ) {{p}_{a}^{j} ( 1 - {p}_{a} )}^{{n}_{2} - j} \qquad [ Equation 25 ]$$

In Equation 25, BLER_{TU} may be an expected BLER of the transmission unit, and pₐ may be an expected BLER of code blocks to be received from the transmitting end after reception of PDSCH 4. pₐ may be a target code block BLER in the first transmission, or may be a value corrected based on the signal quality (e.g., SNR) of code blocks received by the receiving end from the transmitting end.

The receiving end may proactively determine whether retransmission is necessary by comparing the expected BLER of the transmission unit obtained based on Equation 25 with a target BLER of the transmission unit. If the expected BLER of the transmission unit is less than or equal to the target BLER of the transmission unit, the receiving end may feedback a proactive HARQ-ACK to an ACK or perform DTC processing on the proactive HARQ-ACK based on a configuration with the transmitting end.

If the expected BLER of the transmission unit is greater than the target BLER of the transmission unit, the receiving end may transmit a proactive HARQ-ACK to the transmitting end based on a procedure of FIG. 31. The proactive HARQ-ACK may be for requesting the receiving end to perform any one of retransmission of a specific CBG, transmission of an additional PCB, or retransmission of all CBGs received by the receiving end.

If a specific CBG is retransmitted based on the proactive HARQ-ACK feedback, the receiving end may obtain the expected BLER of the transmission unit based on the following Equation 26.

$${BLER}_{T U , g} = 1 - {\sum }_{i = 0}^{{e}_{g}} [ ( \begin{matrix}{e}_{g} \\ i\end{matrix} ) {{q}^{i} ( 1 - q )}^{{e}_{g} - i} {\sum }_{j = 0}^{( n - e + {e}_{g} - i ) - k} ( \begin{matrix}{n}_{2} \\ j\end{matrix} ) {p}_{a}^{j} {( 1 - {p}_{a} )}^{{n}_{2} - j} ] \qquad [ Equation 26 ]$$

In Equation 26, BLER_{TU,g} may be an expected BLER of the transmission unit when a specific CBG is retransmitted. Here, the specific CBG may be CBG g. Referring to Equation 26, if (n−e+e_{g}) is less than k, BLER_{TU,g} may be 1. The receiving end may obtain BLER_{TU,g} when each CBG received is retransmitted. The receiving end may obtain a minimum value among BLER_{TU,g}.

The receiving end may compare the minimum value among BLER_{TU,g} with the target BLER of the transmission unit to determine whether to request CBG retransmission. That is, if the smallest value among BLER_{TU,g} is less than or equal to the target BLER of the transmission unit, the receiving end may transmit the CBG g corresponding to the smallest value BLER_{TU,g} as the proactive HARQ-ACK.

If all BLER_{TU,g} is greater than the target BLER of the transmission unit, the receiving end may obtain an expected BLER of the transmission unit assuming additional PCB transmission. The receiving end may obtain an expected BLER of the transmission unit based on the HARQ-ACK feedback related to the additional PCB transmission. The receiving end may obtain the predicted BLER of the transmission unit assuming additional PCB transmission based on Equation 27.

$${BLER}_{T U , h} = 1 - {\sum }_{j = 0}^{( n + {l}_{h} - e ) - k} ( \begin{matrix}{n}_{2} + {l}_{h} \\ j\end{matrix} ) {{p}_{a}^{j} ( 1 - {p}_{a} )}^{( {n}_{2} + {l}_{h} ) - j} \qquad [ Equation 27 ]$$

BLER_{TU,h} may be an expected BLER of the transmission unit assuming additional PCB transmission. BLER_{TU,h} may be an expected BLER of the transmission unit based on h values. If (n−e+e_{g}) BLER_{TU,h} is less than k, is 1. If there is BLER_{TU,h} which is less than or equal to the target BLER of the transmission unit, the receiving end may transmit to the transmitting end the h value corresponding to the largest value BLER_{TU,h}, which is not greater than the target BLER of the transmission unit, as the proactive HARQ-ACK.

If all BLER_{TU,h} is greater than the target BLER of the transmission unit, the receiving end may transmit the proactive HARQ-ACK value requesting the retransmission of all the CBGs to the transmitting end.

The transmitting end may receive the proactive HARQ-ACK feedback from the receiving end. After the first transmission is completed, the transmitting end may perform retransmission of a specific CBG requested by the receiving end, or transmission of new additional PCBs, or retransmission of all the CBGs that are determined to have been received by the UE until the time at which the UE determines the proactive HARQ-ACK. In addition, the transmitting end may transmit time interval information (K_{P} in FIG. 32) from a start time of the last PDSCH to the time at which the proactive HARQ-ACK is transmitted. The transmitting end may transmit the time interval information to the receiving end via an RRC message, MAC CE, DCI, etc. FIG. 32 illustrates an example in which the receiving end transmits one proactive HARQ-ACK feedback to the transmitting end, but the receiving end may transmit multiple proactive HARQ-ACK feedbacks to the transmitting end, which will be described in detail as follows.

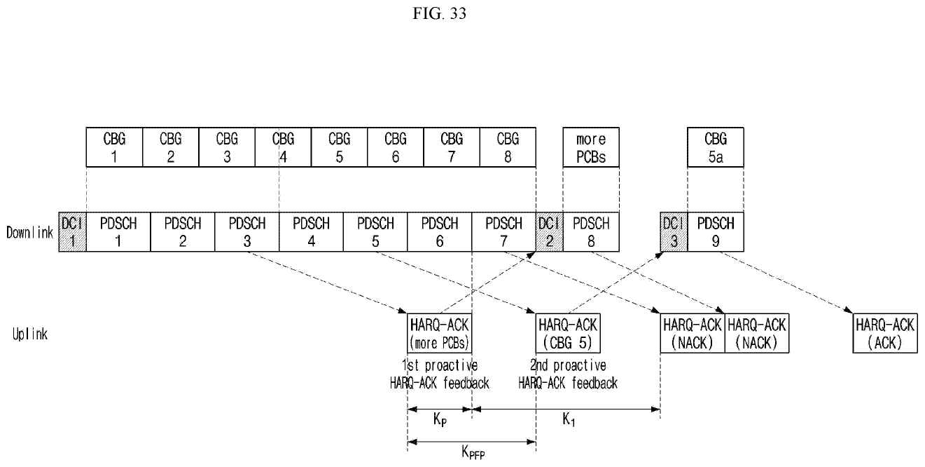

FIG. 33 is a conceptual diagram illustrating a transmission latency reduction method according to another embodiment of the present disclosure.

More specifically, FIG. 33 is a conceptual diagram illustrating an example in which a receiving end performs proactive HARQ-ACK feedback after receiving PDSCH 3 and 5 from a transmitting end.

Referring to FIG. 33, if the receiving end determines that additional PCB transmission is necessary after receiving up to PDSCH 3 from the transmitting end, the receiving end may transmit a first proactive HARQ-ACK feedback to the transmitting end. If the receiving end determines that additional retransmission of CBG 5 is necessary at the time the receiving end receives PDSCH 5 from the transmitting end, the receiving end may transmit a second proactive HARQ-ACK feedback to the transmitting end.

The transmitting end may receive the first proactive HARQ-ACK feedback and the second proactive HARQ-ACK feedback from the receiving end. After the transmitting end transmits up to PDSCH 7, which is the first transmission, to the receiving end, the transmitting end may transmit, to the receiving end, PDSCH 8 including additional PCBs as a response to the first proactive HARQ-ACK feedback. The transmitting end may transmit, to the receiving end, PDSCH 9 including CBG 5a, which is a retransmission of CBG 5, as a response to the second proactive HARQ-ACK feedback.

When the receiving end receives PDSCH 5 and performs the second proactive HARQ-ACK feedback procedure, the receiving end may expect that the transmitting end will transmit PDSCH 8 including new additional PCBs as a response to the first HARQ-ACK feedback. Therefore, the receiving end may obtain the expected BLER of the transmission unit by considering not only reception of PDSCH 1 to PDSCH 7, which are the first transmission, but also the reception of PDSCH 8, and may compare it with the target BLER to determine whether a second retransmission is required. If the expected BLER of the transmission unit is less than or equal to the target BLER, the receiving end may feedback the second proactive HARQ-ACK to ACK or perform DTX processing based on a configuration with the transmitting end.

If the expected BLER of the transmission unit is greater than the target BLER of the transmission unit, the receiving end may determine that a second retransmission is necessary. If the second retransmission is determined to be necessary, the receiving end may generate second proactive HARQ-ACK feedback based on the procedure of FIG. 31. The second proactive HARQ-ACK may be for requesting the transmitting end to perform any one of retransmission of a specific CBG, transmission of additional PCBs, or retransmission of all the CBGs received by the receiving end. If the first transmission unit BLER or the second transmission unit BLER BLER_{TU,g} or BLER_{TU,h}) is acquired based on the procedure of FIG. 31, the receiving end may acquire the first transmission unit BLER and the second transmission unit BLER including not only PDSCHs 1 to 7, which are the first transmission, but also additional PCBs of PDSCH 8 to be transmitted in response to the first HARQ-ACK feedback. If the CBG is retransmitted and new PCBs are transmitted after the first transmission, the receiving end may acquire obtain the BLER of the transmission unit based on Equations 28 to 30.

$${BLER}_{T U} = 1 - {\sum }_{i = 0}^{{e}_{r}} [ ( \begin{matrix}{e}_{r} \\ i\end{matrix} ) {{q}^{i} ( 1 - q )}^{{e}_{r} - i} {\sum }_{j = 0}^{( n + l - e + {e}_{r} - i ) - k} ( \begin{matrix}{n}_{2} + l \\ j\end{matrix} ) {{p}_{a}^{j} ( 1 - {p}_{a} )}^{( {n}_{2} + l ) - j} ] \qquad [ Equation 28 ]$$

$${e}_{r} = {\sum }_{retx - CBG g} {e}_{g} \qquad [ Equation 29 ]$$

$$l = {\sum }_{more - PCB h} {l}_{h} \qquad [ Equation 30 ]$$

In Equations 28 to 30, BLER_{TU} may be the expected BLER of the transmission unit if the CBG is retransmitted and the new PCBs are transmitted after the first transmission, eᵣ may be the number of error code blocks that can be recovered from all the retransmitted CBGs, and may be the number of all new PCBs that can be additionally transmitted. The Equation 28 is a generalized expression that encompasses all the Equations 26 and 27. The Equation 26 may be a case where eᵣ is equal to e_{g} and l is 0, and the Equation 27 may be a case where eᵣ is 0 and l is equal to lₕ.

As described above, an external erasure code may be applied to a single transmission unit data, and multiple DCBs and one or more PCBs may be generated and then transmitted through multiple shared channels. The base station may transmit necessary information to the UE via RRC message, MAC CE, DCI, etc. so that the UE can perform the proactive HARQ-ACK feedback.

The transmitting end may transmit the following information to the receiving end via RRC message or MAC CE, etc.

Information for determining a quantization step when determining the size and number of code blocks (decision algorithm of x_{bias} and related information)

A table consisting of items for a target BLER of a code block, a target BLER of a transmission unit, or the maximum number of all code blocks (nₘₐₓ) per the number of PCBs (n−k)

The minimum number of DCBs (k_{OC.min}) for using an external erasure code, that is, for generating and transmitting PCBs

The maximum size of a transmission block (IBSₘₐₓ)

The minimum number of code blocks per CBG (n_{CBG,min}))

The maximum number of CBGs (N_{CBG})

The number of HARQ-ACK transmission bits (N_{HARQ-ACK})

Time domain resource assignment (TDRA) list—A list of time domain resource assignment information for multiple shared channels

PUCCH resource list—a list of PUCCH resources for transmitting HARQ-ACK

HARQ-ACK feedback time (PDSCH-to-HARQ Feedback Timing) list-A list consisting of multiple items including time information ( ) for transmitting HARQ-ACK after the UE receives all shared channels and time information (K_{P}, K_{PFP}) for transmitting proactive HARQ-ACK

The transmitting end may transmit the following information to the receiving end via DCI.

The transmitting end may transmit the following information to the receiving end via DCI.

Frequency Domain Resource Assignment (FDRA) information—The base station may allocate resources of the same frequency domain to all shared channels.

Time Domain Resource Assignment (TDRA) information—The base station may inform the number of shared channels and time domain resources allocated to each shared channel by transmitting a list of time domain resources allocation for multiple shared channels via RRC message, etc., and transmitting an index of the list via DCI.

Modulation and Coding Scheme (MCS)—The base station may transmit an index of an MCS table, which has been pre-arranged or transmitted via RRC message, via DCI. The same MCS may be applied to all shared channels.

New Data Indicator (NDI)—It informs whether data of a transmission unit is new data that has not been transmitted before.

### Redundancy Version (RV)

HARQ Process Number (HPN)—It delivers the HPN that applies equally to all shared channels transmitting data of one transmission unit.

Transmitting Code Block Information (TCBI)—It transmits information on code blocks being transmitted as shown in Tables 9 and 10.

PUCCH resource indicator—It transmits PUCCH resource information for transmitting HARQ-ACK as an index of a PUCCH resource list transmitted via RRC messages, etc.

HARQ-ACK feedback timing indicator (PDSCH-to-HARQ Feedback Timing Indicator)—After the UE receives all shared channels, the UE transmits time information (K₁ of FIGS. 32 and 33) for transmitting HARQ-ACK and time information (of K_{P} of FIGS. 32 and 33 and K_{PFP} FIG. 33) for transmitting proactive HARQ-ACK. The base station may transmit a list consisting of multiple (K₁, K_{P}, K_{PFP}) items via RRC message, etc., and transmit an index of the list via DCI.

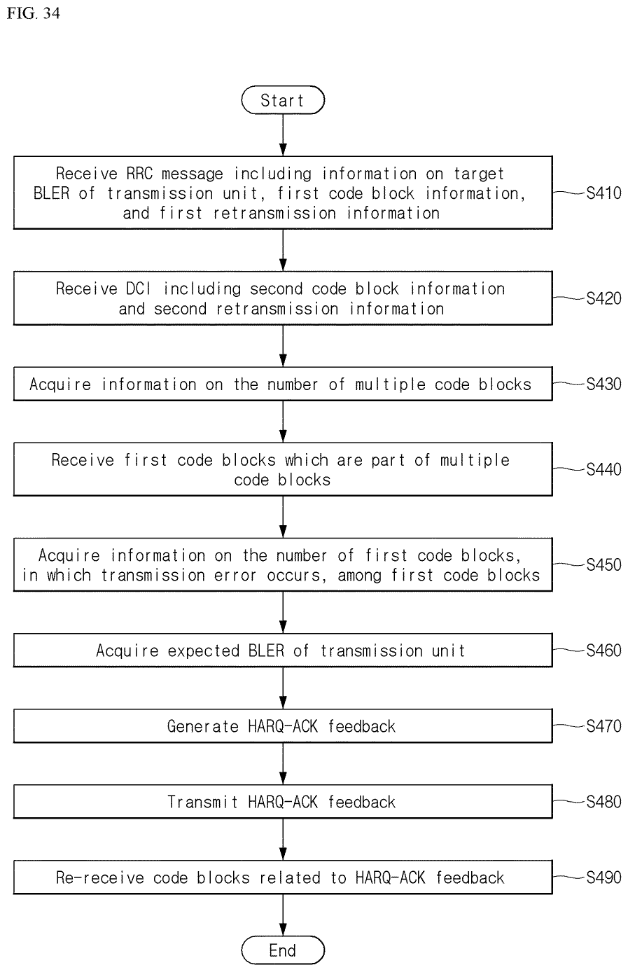

FIG. 34 is a flowchart illustrating an operation procedure of a UE according to an embodiment of the present disclosure.

Below, the above-described embodiments are described in detail from an operation perspective of a UE with reference to FIG. 34. Methods to be described below are merely distinguished for convenience of explanation. Thus, as long as the methods are not mutually exclusive, it is obvious that partial configuration of any method can be substituted or combined with partial configuration of another method. The UE of FIG. 34 may correspond to the above-described receiving end, and a base station may correspond to the above-described transmitting end.

An embodiment of FIG. 34 may include, before step S3410, a step of receiving, by a UE, one or more synchronization signals from a base station and a step of receiving, by the UE, one or more system information from the base station.

The embodiment of FIG. 34 may further include, before the step S3410, a step of transmitting, by the UE, a random access preamble to the base station, a step of receiving, by the UE, a random access response from the base station, and a step of receiving, by the UE, control information from the base station.

Referring to FIG. 34, the UE may receive, from the base station, an RRC message including information on a target BLER of a transmission unit including multiple code blocks, first code block information for the multiple code blocks, and first retransmission information for multiple HARQ-ACKs, in S3410. The first code block information may include information for determining a quantization step when the UE determines a size and number of code blocks, information on a table consisting of items such as a target BLER of the code block and the target BLER of the transmission unit, or a maximum number of all the code blocks per the number of PCBs (n−k) (e.g., Table 6), information on a minimum number of DCBs in which the base station can generate and transmit the PCBs, information on a maximum size of a transfer block, and information on a minimum number of code blocks per CBG or information on a maximum number of CBGs.

The first retransmission information may include at least one of information on the number of HARQ-ACK transmission bits, information on a time domain resource assignment list, or information on a HARQ-ACK feedback time.

The UE may receive, from the base station, DCI including second code block information for the multiple code blocks and second retransmission information for the multiple HARQ-ACKs, in S3420. After the UE receives all shared channels, the DCI may include time information for transmitting the HARQ-ACKs and time information for transmitting preemptive HARQ-ACK. The second code block information may include at least one of frequency domain resource assignment information, time domain resource assignment information, MCS information, information on a new data indicator, or information on a redundancy version.

Second HARQ-ACK information may include at least one of a HARQ process number, transmitted code block information, PUCCH resource indicator information, or HARQ-ACK feedback timing indicator information.

The UE may acquire information on the number of the multiple code blocks based on the first code block information and the second code block information, in S3430. The UE may acquire information on the number of the multiple code blocks by obtaining the number of bits based on the second information, performing quantization on the number of bits based on the first information, and obtaining information on the number of the multiple code blocks based on the number of bits on which the quantization is performed and a maximum size of the multiple code blocks. The UE may perform the quantization by generating at least one group based on the number of bits and applying a different bias value to each of the at least one group.

The UE may acquire information on the number of DCBs, the number of PCBs, and the number of CBGs based on the number of the multiple code blocks, based on at least one of the first code block information and the second code block information.

The UE may receive first code blocks, which are a part of the multiple code blocks, from the base station, in S3440. The UE may obtain the number of the first code blocks from the total number of the multiple code blocks obtained in S3430.

The UE may acquire information on the number of first code blocks, in which a transmission error occurs, among the first code blocks, in S3450. The UE may obtain the number of first code blocks, in which no transmission error occurs, by subtracting the number of first code blocks, in which the transmission error occurs, from the total number of first code blocks.

The UE may obtain an expected BLER of the transmission unit based on the number of the first code blocks, the number of the first code blocks in which the transmission error occurs, and an expected BLER of second code blocks which are a remaining part of the multiple code blocks, in S3460. Here, the BLER may be a target BLER of the code block in a first transmission or may be a value corrected based on the signal quality of the first code blocks.

The UE may generate HARQ-ACK feedback based on the target BLER of the transmission unit, the expected BLER of the transmission unit, and the first retransmission information, in S3470. If the expected BLER of the transmission unit is less than or equal to the target BLER of the transmission unit, the UE may generate an ACK with the HARQ-ACK feedback or perform discontinuous transmission (DTX) processing. If the expected BLER of the transmission unit is greater than the target BLER of the transmission unit, the UE may generate the HARQ-ACK feedback for requesting at least one of retransmission of a specific CBG, transmission of an additional PCB, or retransmission of all CBGs.

The UE may transmit the HARQ-ACK feedback to the base station based on the second retransmission information, in S3480.

The UE may re-receive code blocks related to the HARQ-ACK feedback, in S3490. In response to S3480, the UE may re-receive from the base station code blocks transmitted on a per CBG basis. For example, the UE may re-receive a specific CBG, receive an additional PCB, or re-receive all the CBGs from the base station.

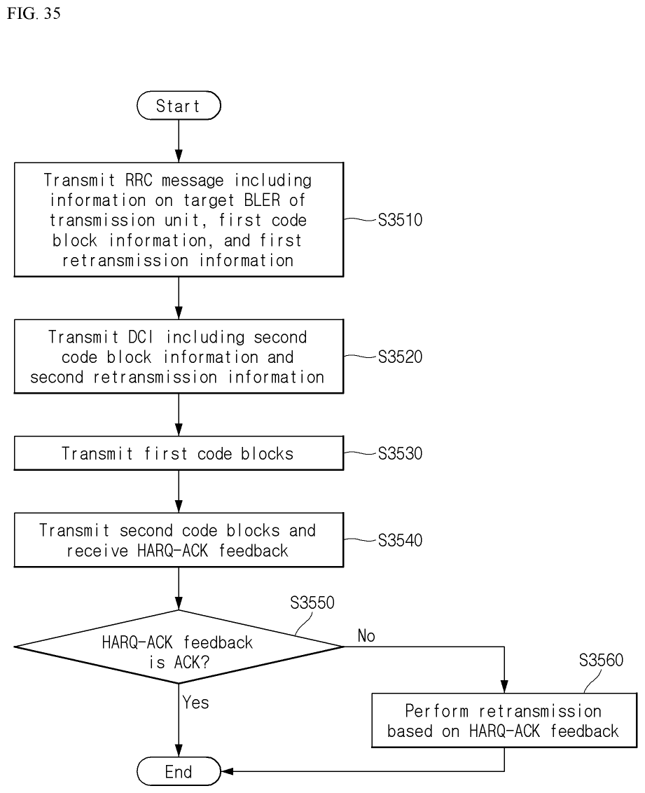

FIG. 35 is a flowchart illustrating an operation procedure of a base station according to an embodiment of the present disclosure.

Below, the above-described embodiments are described in detail from an operation perspective of a base station with reference to FIG. 35. Methods to be described below are merely distinguished for convenience of explanation. Thus, as long as the methods are not mutually exclusive, it is obvious that partial configuration of any method can be substituted or combined with partial configuration of another method. The UE of FIG. 35 may correspond to the above-described receiving end, and a base station may correspond to the above-described transmitting end.

An embodiment of FIG. 35 may include, before step S3510, a step of transmitting, by a base station, one or more synchronization signals to a UE and a step of transmitting, by the base station, one or more system information to the UE.

The embodiment of FIG. 35 may further include, before the step S3510, a step of receiving, by the base station, a random access preamble from the UE, a step of transmitting, by the base station, a random access response to the UE, and a step of transmitting, by the base station, control information to the UE.

Referring to FIG. 35, the base station may transmit, to the UE, an RRC message including information on a target BLER of a transmission unit including multiple code blocks, first code block information for the multiple code blocks, and first retransmission information for multiple HARQ-ACKs, in S3510.

The base station may transmit, to the UE, DCI including second code block information for the multiple code blocks and second retransmission information for the multiple HARQ-ACKs, in S3520.

The base station may transmit, to the UE, first code blocks, which are a part of multiple code blocks included in a transmission unit, in S3530. The first code blocks may include multiple DCBs and one or more PCBs.

The base station may transmit second code blocks included in the transmission unit to the UE and receive HARQ-ACK feedback from the UE, in S3540. The HARQ-ACK feedback may be proactive HARQ-ACK feedback. The proactive HARQ-ACK feedback may be generated based on a reception state of the first code blocks. The HARQ-ACK feedback may be ACK or NACK. The NACK may be for the UE to request the base station to retransmit a specific CBG, transmit an additional PCB, or retransmit all CBGs.

The base station may check whether the HARQ-ACK feedback is ACK, in S3550. If the HARQ-ACK feedback is the ACK (YES in S3550), the base station may terminate a procedure without performing a retransmission.

If the HARQ-ACK feedback is NACK (NO in S3550), the base station may perform a retransmission based on the HARQ-ACK feedback, in S3560. Based on the HARQ-ACK feedback, the base station may perform a retransmission of a specific CBG, a transmission of an additional PCB, or a retransmission of all the CBGs. The base station may perform the retransmission immediately after a transmission of a second transport block is completed in step S3560.

According to the present disclosure, when a large amount of data is transmitted through multiple shared channels scheduled via one DCI, a technology is provided that reduces transmission latency by lowering the probability of retransmission using an erasure code, and reduces transmission latency through the proactive HARQ-ACK feedback when retransmission is inevitably required.

According to the present disclosure, when retransmission is required compared to the multi-slot scheduling technology and the CBG-based retransmission technology of 5G NR, an amount of required radio resources can be reduced by retransmitting only some CBGs or transmitting a small number of additional PCBs instead of retransmitting all the shared channels or all the CBGs in which errors occur.

According to the present disclosure, the HARQ-ACK feedback and the number of DCI bots can be reduced compared to the multi-slot scheduling technology and the CBG-based retransmission technology of 5G NR. The multi-slot scheduling technology requires as many HARQ-ACK bits as N_{SCH} via uplink control information (UCI) and NDI and as many RV bits as N_{SCH} via DCI when the maximum number of shared channels is. The CBG-based retransmission requires as many HARQ-ACK bits as N_{CBG} via UCI and as many CBGT (Code Block Group Transmission Information) bits as N_{CBG} via DCI when the maximum number of CBGs is N_{CBG} The present disclosure requires as many bits as ┌log₂ N_{CBG}┐ or (1+┌log₂ N_{CBG}┐) for HARQ-ACK and TCBI, respectively. Therefore, as N_{SCH} increases compared to ┌log₂ N_{CBG}┐ or as N_{CBG} increases, the number of bits of UCI and DCI can be further reduced.

According to the present disclosure, a technology is provided that can recover code blocks in which errors occur using code blocks in which no error occur, thereby obtaining diversity gain when signal quality between the code blocks is not constant.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by subsequent amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memories may be located at the interior or exterior of the processors and may transmit data to and receive data from the processors via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

1. A method comprising:
receiving one or more synchronization signals from a base station;
receiving configuration information from the base station;
receiving control information from the base station;
receiving, from the base station, a radio resource control (RRC) message including information for a target block error rate (BLER) of a transmission unit including multiple code blocks, first code block information for the multiple code blocks, and first retransmission information for a hybrid automatic repeat request-acknowledgment (HARQ-ACK);
receiving, from the base station, downlink control information (DCI) including second code block information for the multiple code blocks and second retransmission information for the HARQ-ACK;
acquiring information for a number of the multiple code blocks based on the first code block information and the second code block information;
receiving, from the base station, first code blocks which are a part of the multiple code blocks;
acquiring a number of first code blocks in which a transmission error occurs among the first code blocks;
acquiring an expected BLER of the transmission unit based on a number of the first code blocks, the number of the first code blocks in which the transmission error occurs, and an expected BLER of second code blocks which are a remaining part of the multiple code blocks;
generating a HARQ-ACK feedback based on the target BLER of the transmission unit, the expected BLER of the transmission unit, and the first retransmission information;
transmitting the HARQ-ACK feedback to the base station based on the second retransmission information; and
re-receiving, from the base station, code blocks related to the HARQ-ACK feedback.

2. The method of claim 1, wherein at least one of the first retransmission information or the second retransmission information includes transmission time information of a proactive HARQ-ACK.

3. The method of claim 1, wherein acquiring the information for the number of the multiple code blocks comprises:
acquiring a number of bits based on the second code block information;
performing a quantization on the number of bits based on the first code block information; and
acquiring the information for the number of the multiple code blocks based on the number of bits on which the quantization is performed and a maximum size of the multiple code blocks.

4. The method of claim 3, wherein performing the quantization on the number of bits based on the first code block information comprises:
generating at least one group based on the number of bits; and
applying a different bias value to each of the at least one group.

5. The method of claim 1, wherein re-receiving, from the base station, the code blocks related to the HARQ-ACK feedback comprises re-receiving the code blocks related to the HARQ-ACK feedback on a per CBG basis.

6. The method of claim 1, further comprising:
acquiring information for a number of data code blocks (DCBs), information for a number of parity code blocks (PCBs), and information for a number of code block groups (CBGs) based on the first code block information, the second code block information, or the number of the multiple code blocks.

7. The method of claim 6, wherein acquiring the information for the number of the CBGs comprises acquiring the information for the number of the CBGs based on information for a minimum number of code blocks per CBG and information for a maximum number of the CBGs.

8. A user equipment (UE) comprising:
a transceiver;
a memory including at least one instruction; and
at least one processor performing the at least one instruction,
wherein the at least one instruction comprises:
receiving one or more synchronization signals from a base station;
receiving configuration information from the base station;
receiving control information from the base station;
receiving, from the base station, a radio resource control (RRC) message including information for a target block error rate (BLER) of a transmission unit including multiple code blocks, first code block information for the multiple code blocks, and first retransmission information for a hybrid automatic repeat request-acknowledgment (HARQ-ACK);
receiving, from the base station, downlink control information (DCI) including second code block information for the multiple code blocks and second retransmission information for the HARQ-ACK;
acquiring information for a number of the multiple code blocks based on the first code block information and the second code block information;
receiving, from the base station, first code blocks which are a part of the multiple code blocks;
acquiring a number of first code blocks in which a transmission error occurs among the first code blocks;
acquiring an expected BLER of the transmission unit based on a number of the first code blocks, the number of the first code blocks in which the transmission error occurs, and an expected BLER of second code blocks which are a remaining part of the multiple code blocks;
generating a HARQ-ACK feedback based on the target BLER of the transmission unit, the expected BLER of the transmission unit, and the first retransmission information;
transmitting the HARQ-ACK feedback to the base station based on the second retransmission information; and
re-receiving, from the base station, code blocks related to the HARQ-ACK feedback.

9. The UE of claim 8, wherein at least one of the first retransmission information or the second retransmission information includes transmission time information of a proactive HARQ-ACK.

10. The UE of claim 8, wherein acquiring the information for the number of the multiple code blocks comprises:
acquiring a number of bits based on the second code block information;
performing a quantization on the number of bits based on the first code block information; and
acquiring the information for the number of the multiple code blocks based on the number of bits on which the quantization is performed and a maximum size of the multiple code blocks.

11. The UE of claim 10, wherein performing the quantization on the number of bits based on the first code block information comprises:
generating at least one group based on the number of bits; and
applying a different bias value to each of the at least one group.

12. The UE of claim 8, wherein re-receiving, from the base station, the code blocks related to the HARQ-ACK feedback comprises re-receiving the code blocks related to the HARQ-ACK feedback on a per CBG basis.

13. The UE of claim 8, wherein the at least one instruction further comprises acquiring information for a number of data code blocks (DCBs), information for a number of parity code blocks (PCBs), and information for a number of code block groups (CBGs) based on the first code block information, the second code block information, or the number of the multiple code blocks.

14. The UE of claim 13, wherein acquiring the information for the number of the CBGs comprises acquiring the information for the number of the CBGs based on information for a minimum number of code blocks per CBG and information for a maximum number of the CBGs.

15-17. (canceled)

18. A base station comprising:
a transceiver;
a memory including at least one instruction; and
at least one processor performing the at least one instruction,
wherein the at least one instruction comprises:
transmitting one or more synchronization signals to a user equipment (UE);
transmitting configuration information to the UE;
transmitting control information to the UE;
transmitting, to the UE, a radio resource control (RRC) message including information for a target block error rate (BLER) of a transmission unit including multiple code blocks, first code block information for the multiple code blocks, and first retransmission information for a hybrid automatic repeat request-acknowledgment (HARQ-ACK);
transmitting, to the UE, downlink control information (DCI) including second code block information for the multiple code blocks and second retransmission information for the HARQ-ACK;
transmitting, to the UE, first code blocks which are a part of the multiple code blocks included in the transmission unit;
transmitting, to the UE, second code blocks which are a remaining part of the multiple code blocks;
receiving, from the UE, a HARQ-ACK feedback generated based on a reception state of the first code blocks; and
re-transmitting, to the UE, code blocks related to the HARQ-ACK feedback based on the HARQ-ACK feedback.

19-20. (canceled)
